(19) United States
(12) Patent Application Publication
(10) Pub. No.: US 2025/0061682 A1
(43) Pub. Date: Feb. 20, 2025

(54) EFFICIENT SEGMENTATION OF TUMOURS FROM LUNG CT

(71) Applicant: IDEAS - INSTITUTE OF DATA ENGINEERING, ANALYTICS AND SCIENCE FOUNDATION, Kolkata (IN)

(72) Inventors: SUSHMITA MITRA, Kolkata (IN); SUROCHITA PAL DAS, Kolkata (IN); B. UMA SHANKAR, Kolkata (IN)

(21) Appl. No.: 18/409,137

(22) Filed: Jan. 10, 2024

(30) Foreign Application Priority Data
Aug. 11, 2023 (IN) 202331054137

(51) Int. Cl. G06V 10/26; G06T 3/40; G06T 7/00; G06V 10/25; G06V 10/77; G06V 10/771; G06V 10/82

(52) U.S. Cl. CPC G06V 10/273; G06T 3/40; G06T 7/0012; G06V 10/25; G06V 10/267; G06V 10/771; G06V 10/7715; G06V 10/82; G06T 2207/10081; G06T 2207/20081; G06T 2207/20084; G06T 2207/30061; G06T 2207/30096; G06V 2201/03

(57) ABSTRACT

A Convolutional Neural network (CNNs) based system and method based on the same for image analysis including for computer aided detection/diagnosis is provided, enabling an efficient and accurate delineation of diseased volumes in images/medical images. More particularly, the system of the present invention is adapted to incorporate deformable convolution (DC) module based processor means, along the down- and up-sampling pathways of the underlying U-Net architectural framework of said system for effective understanding and attending to deformable geometry of unknown transformations, considering deformable convolution (DC), unlike the basic convolution is advantageously not constrained by predefined geometrical structures of the kernels. Said system of the present invention advantageously also permits weighted combination of image feature components along the encoder and decoder arms of the deformable convolution (DC) processor module based system architectural network due to introduction of Weight Generation (WG) modules in said system, such that dynamic assignment of importance to relevant spatial locations of the corresponding image feature maps could be given so as to also boost overall accuracy while ensembling to enable reduction in module analytic error by simultaneously maintaining the generalization in performance in respect of robustness to noise to attain accurate and faster demarcation of the ROI (region of interest). Added to the aforesaid, preferred integration of Focal Asymmetric Similarity (F AS) loss function analytic based processor module/means in said system, allowed effective handling of class imbalance for further improved performance.

### CROSS REFERENCE TO RELATED APPLICATION(S)

This application is related to and claims priority to Indian Patent Application No. 202331054137 filed on Aug. 11, 2023, the contents of which are incorporated by reference herein.

### FIELD OF INVENTION

The present invention provides for Convolutional Neural network (CNNs) based system and method based on the same for image analysis including for computer aided detection/diagnosis enabling an efficient and accurate delineation of diseased volumes in images/medical images. More particularly, the system of the present invention is adapted to incorporate deformable convolution (DC) module based processor means, along the down- and up-sampling pathways of the underlying U-Net architectural framework of said system for effective understanding and attending to deformable geometry of unknown transformations, considering deformable convolution (DC), unlike the basic convolution is advantageously not constrained by predefined geometrical structures of the kernels. Said system of the present invention advantageously also permits weighted combination of image feature components along the encoder and decoder arms of the deformable convolution (DC) processor module based system architectural network due to introduction of Weight Generation (WG) modules in said system, such that dynamic assignment of importance to relevant spatial locations of the corresponding image feature maps could be given so as to also boost overall accuracy while ensembling to enable reduction in module analytic error by simultaneously maintaining the generalization in performance in respect of robustness to noise to attain accurate and faster demarcation of the ROI (region of interest). Added to the aforesaid, preferred integration of Focal Asymmetric Similarity (F AS) loss function analytic based processor module/means in said system allowed effective handling of class imbalance for further improved performance.

### BACKGROUND ART

Lung cancer is the leading cause of cancer-related death in the developed countries, with about 80% of lung cancer patients being clinically symptomatic. Of these around 85% of the total cases are broadly classified as non-small cell lung carcinoma (NSCLC) [1]. Approximately half of the NSCLC cases are localized at diagnosis, and treated either by surgical resection alone or a combination therapy with/without resection. The five-year survival rate for lung cancer is just 17.8%, which is much lower than that of other major malignancies. Classification of tumor stage is a cornerstone of providing uniform consistent care for patients with cancer worldwide [2]. NSCLCs can be centrally located masses, invading the mediastinal structures, or peripherally situated lesions that invade the chest wall [3]. Tumors can have margins which are smooth, lobulated or irregular and spiculated. They can be uniformly solid or can have central necrosis and cavitation. Sometimes the tumor resembles an infective pathology and is seen as an area of consolidation, a ground-glass opacity, or a combination of both. CT is currently the primary means for screening and monitoring lung cancer in clinics. Improving the specificity and sensitivity of lung cancer screening is imperative because of the high clinical and financial costs of missed diagnosis, late diagnosis, and unnecessary biopsy procedures resulting from false negatives and false positives. Deep learning approaches offer the exciting potential to automate complex image analysis, detect subtle holistic image findings, and unify methodologies for image evaluation. Convolutional neural networks (CNNs) have been used [4] in an end-to-end approach, based on a patient's current and prior CT volumes, to predict the risk of lung cancer. The ability to predict the radiologic response to treatment depends on the accurate demarcation of the tumor [5]. The precise segmentation of the gross tumor volume and the adjacent organs-at-risk is advantageous for radiation therapy planning. This is (i) critical, because subsequent feature extraction depends on its accuracy, (ii) challenging, as many tumors have indistinct borders, and (iii) contentious, since there exist ongoing debates regarding the relative merits of ground truth vs. reproducibility and manual vs automated segmentation issues. In order to overcome the problems of inherent human bias and uncertainty in manual segmentation, the need for an automated or semi-automated Computer Aided Diagnosis becomes apparent; particularly in today's big data scenario. It can also serve to improve the accuracy in automatic detection in order to assist doctors in diagnosing faster and on time. Investigations with CT images of NSCLC helped establish the effectiveness of semi-automated segmentation vis-a-vis the manual one [6]. Use of extracted quantitative imaging biomarkers [7], and a single-click ensembled segmentation [8] are available in literature. The Fully Convolutional Net (FCN) [9] and U-Net [10] have been successfully employed in medical image segmentation, with extensive use of 2D, 2.5D, and 3D U-Net models being reported [11-13]. Effective segmentation of lung tumors has also been attempted, using the U-Net and its variants. The adaptable feature fusion approach in U-Net++ [14] redesigned skip connections to collect characteristics at various semantic scales of the decoder sub-networks. The deep residual U-Net [15] employed multi-view learning for segmentation. The CoLe-CNN model [16] captured the context of nodules with an adaptive loss function. Use of transfer learning has also been reported [17] for lung tumor segmentation. Deep residual separable CNN [18] used maximum intensity projection-based pre-processing to precisely outline tumors. The Dualbranch residual network (DB-ResNet) [19] included an intensity-pooling layer with multi-scaling. The multiscale squeeze-and-excitation U-Net incorporated conditional random field [20] for tumor segmentation. A student model performed automated tumor segmentation, guided by additional pseudo-annotated data from a teacher, in the teacher-student framework of Ref. [21].

Added to the above while deformable convolution (DC) module based processor means in imaging systems were known to perform well in object detection [22], their role still remained to be explored towards faster and accurate semantic segmentation of medical images considering the special identified advantage residing in deformable convolution (DC) module to not be constrained by predefined geometrical structures of the kernels unlike basic convolution, to thus attain wide ranging ramifications in healthcare for fast screening and accurate diagnosis of cancer tumors and/or other diseased (or infected) volumes (or regions), particularly, those involving complicated and unknown outer boundaries.

References: [1] S. Chheang and K. Brown, “Lung cancer staging: Clinical and radiologic perspectives,” Semin. Intervent. Radiol., vol. 30, pp. 99-113, 2013; [2] F. C. Detterbeck, D. J. Boffa, A. W. Kim, and L. T. Tanoue, “The Eighth Edition of Lung Cancer Stage Classification,” Chest, vol. 151, no. 1, pp. 193-203, 2017; [3] N. C. Purandare and V. Rangarajan, “Imaging of lung cancer: Implications on staging and management,” Indian Journal of Radiology and Imaging, vol. 25, pp. 109-118, 2015; [4] D. Ardila, A. P. Kiraly, and et al., “End-to-end lung cancer screening with three-dimensional deep learning on low-dose chest computed tomography,” Nature Medicine, pp. 954-961, 2019; [5] S. Hayes, M. Pietanza, et al., “Comparison of CT volumetric measurement with RECIST response in patients with lung cancer,” European Journal of Radiology, vol. 85, pp. 524-533, 2016; [6] C. Parmar, E. R. Velazquez, R. Leijenaar, M. Jermoumi, S. Carvalho, R. H. Mak, S. Mitra, and et al., “Robust radiomics feature quantification using semiautomatic volumetric segmentation,” PLoS One, vol. 9, p. e102107, 2014; [7] L. Lu, D. Wang, et al., “A quantitative imaging biomarker for predicting disease-free-survival-associated histologic subgroups in lung adenocarcinoma,” European Radiology, vol. 30, pp. 3614-3623, 2020; [8] Y. Gu, V. Kumar, et al., “Automated delineation of lung tumors from CT images using a single click ensemble segmentation approach,” Pattern Recognition, vol. 46, pp. 692-702, 2013; [9] J. Long, E. Shelhamer, et al., “Fully convolutional networks for semantic segmentation,” in Proceedings of the IEEE Conference on Computer Vision and Pattern Recognition, pp. 3431-3440, 2015; [10] O. Ronneberger, P. Fischer, et al., “U-Net: Convolutional networks for biomedical image segmentation,” in Medical Image Computing and Computer-Assisted Intervention-MICCAI 2015: 18th International Conference, Munich, Germany, Oct. 5-9, 2015, Proceedings, Part III 18, pp. 234-241, Springer, 2015; [11] X. Chen, X. Wang, et al., “Recent advances and clinical applications of deep learning in medical image analysis,” Medical Image Analysis, vol. 79, p. 102444, 2022; [12] H. Guan and M. Liu, “Domain adaptation for medical image analysis: A survey,” IEEE Transactions on Biomedical Engineering, vol. 69, pp. 1173-1185, 2022; [13] L. Wang, H. Wang, et al., “Trends in the application of deep learning networks in medical image analysis: Evolution between 2012 and 2020,” European Journal of Radiology, vol. 146, p. 110069, 2022; [14] Z. Zhou, M. M. R. Siddiquee, et al., “UNet++: Redesigning skip connections to exploit multiscale features in image segmentation,” IEEE Transactions on Medical Imaging, vol. 39, pp. 1856-1867, 2019. [15] M. Usman, B.-D. Lee, et al., “Volumetric lung nodule segmentation using adaptive ROI with multi-view residual learning,” Scientific Reports, vol. 10, p. 12839, 2020; [16] G. Pezzano, V. R. Ripoll, et al., “CoLe-CNN: Context-learning convolutional neural network with adaptive loss function for lung nodule segmentation,” Computer Methods and Programs in Biomedicine, vol. 198, p. 105792, 2021; [17] M. Nishio, K. Fujimoto, et al., “Lung cancer segmentation with transfer learning: Usefulness of a pretrained model constructed from an artificial dataset generated using a generative adversarial network,” Frontiers in Artificial Intelligence, vol. 4, p. 694815, 2021; [18] P. Dutande, U. Baid, et al., “Deep residual separable convolutional neural network for lung tumor segmentation,” Computers in Biology and Medicine, vol. 141, p. 105161, 2022; [19] H. Cao, H. Liu, et al., “Dual-branch residual network for lung nodule segmentation,” Applied Soft Computing, vol. 86, p. 105934, 2020; [20] B. Zhang, S. Qi, et al., “Multi-scale segmentation squeeze-and-excitation UNet with conditional random field for segmenting lung tumor from CT images,” Computer Methods and Programs in Biomedicine, vol. 222, p. 106946, 2022; [21] V. Fredriksen, S. O. M. Sevle, et al., “Teacher-student approach for lung tumor segmentation from mixed-supervised datasets,” Plos ONE, vol. 17, p. e0266147, 2022; [22] J. Dai, H. Qi, et al., “Deformable convolutional networks,” in 2017 IEEE International Conference on Computer Vision (ICCV), pp. 764-773, 2017; [23] H. J. Aerts, E. R. Velazquez, et al., “Decoding tumour phenotype by noninvasive imaging using a quantitative radiomics approach,” Nature Communications, vol. 5, pp. 1-9, 2014; [24] S. Bakr, O. Gevaert, et al., “A radiogenomic dataset of non-small cell lung cancer,” Scientific Data, vol. 5, pp. 1-9, 2018; [25] M. Antonelli, A. Reinke, et al., “The medical segmentation decathlon,” Nature Communications, vol. 13, pp. 1-13, 2022; [26] S. G. Armato III, G. McLennan, et al., “The lung image database consortium (LIDC) and image database resource initiative (IDRI): A completed reference database of lung nodules on CT scans,” Medical Physics, vol. 38, pp. 915-931, 2011. [27] R. Paul, S. H. Hawkins, et al., “Combining deep neural network and traditional image features to improve survival prediction accuracy for lung cancer patients from diagnostic ct,” in 2016 IEEE International Conference on Systems, Man, and Cybernetics (SMC), pp. 002570-002575, IEEE, 2016; [28] B. Zhao, L. P. James, et al., “Evaluating variability in tumor measurements from same-day repeat CT scans of patients with non-small cell lung cancer,” Radiology, vol. 252, pp. 263-272, 2009; [29] T.-Y. Lin, P. Goyal, et al., “Focal loss for dense object detection,” IEEE Transactions on Pattern Analysis and Machine Intelligence, vol. 42, pp. 318-327, 2017; [30] S. R. Hashemi, S. S. M. Salehi, et al., “Asymmetric loss functions and deep densely-connected networks for highly-imbalanced medical image segmentation: Application to multiple sclerosis lesion detection,” IEEE Access, vol. 7, pp. 1721-1735, 2018; [31] U. Kamal, A. M. Rafi, et al., “Lung cancer tumor region segmentation using recurrent 3D-denseunet,” in Thoracic Image Analysis: Second International Workshop, TIA 2020, MICCAI 2020, Lima, Peru, Oct. 8, 2020, Proceedings 2, pp. 36-47, Springer, 2020; [32] S. Hossain, S. Najeeb, et al., “A pipeline for lung tumor detection and segmentation from CT scans using dilated convolutional neural networks,” in ICASSP 2019-2019 IEEE International Conference on Acoustics, Speech and Signal Processing (ICASSP), pp. 1348-1352, IEEE, 2019.

### OBJECTS OF THE INVENTION

Thus the basic object of the present invention is to provide for a Convolutional Neural network (CNNs) based system and method based on the same for image analysis including for computer aided detection/diagnosis comprising deep Weighted Deformable Segmentation Network (WDU-Net), that would enable an efficient and accurate delineation of diseased volumes in images/medical images including in images generated of lung tumors from CT slices.

It is another object of the present invention to provide for said Convolutional Neural network (CNNs) based system and method based on the same that would encompass a unique deep learning framework for effectively segmenting of affected regions of varying shapes and sizes, including severe class imbalance; towards faster and accurate detection/diagnosis and/or prognosis that would be expected to function as assistive intelligence to human medical experts for effectively handling the large volumes of data being continuously generated in the healthcare domain.

It is still another object of the present invention to provide for said Convolutional Neural network (CNNs) based system and method that would be extendable to accurate segmentation of any additional/other diseased volumes in humans medical images even when the images would involve different imaging modalities including MRI, PET, MRS, SPECT, and others.

It is yet another object of the present invention to provide for said Convolutional Neural network (CNNs) based system and method implementable in respect of 2D slices, mainly because of the limited availability of annotated data and crunch in available computational power, but also that can be seamlessly extended to the volumetric framework.

It is a further object of the preset invention to provide for said Convolutional Neural network (CNNs) based system and method that would be adapted to incorporate deformable convolution (DC) module based processor means, along the down- and upsampling pathways of the underlying U-Net framework, for effective understanding and attending to deformable geometry of unknown transformations, considering deformable convolution (DC), unlike the basic convolution is advantageously not constrained by predefined geometrical structures of the kernels.

It is another object of the present invention to provide for said Convolutional Neural network (CNNs) based system and method to explore their role in the semantic segmentation of medical images and to attain wide ranging ramifications in healthcare, for fast screening and accurate diagnosis of cancer tumors and/or other diseased (or infected) volumes (or regions); particularly, those involving complicated and unknown outer boundaries.

It is yet another object of the present invention to provide for said Convolutional Neural network (CNNs) based system and method which in including deformable convolution (DC) module would enable analysis/learning of dynamic receptive field, by allowing the sampling grid to be deformed in free form through the addition of 2D offsets to the grid sampling points of an ordinary convolution.

It is still another object of the present invention to provide for said Convolutional Neural network (CNNs) based system and method that would enable incorporation of additional convolution (DC) layers to analyze/learn the offsets from the preceding feature maps such that the deformation is local, dense, and adaptively conditioned on the input attributes with DC permitting benefits of an adaptive receptive field, which is learned from the data and varies according to the scale and shape of the object (ROI).

It is a further object of the present invention to provide for said Convolutional Neural network (CNNs) based system and method that would enable weighted combination of components along the encoder and decoder arms of the system architectural network through the introduction of Weight Generation (WG) modules, such that dynamic assignment of importance to relevant spatial locations of the corresponding feature maps could be given.

It is yet another object of the present invention to provide for said Convolutional Neural network (CNNs) based system and method whereby introduction of Weight Generation (WG) modules, would help minimize the time complexity in conventional deep models, while enhancing interpretability and parallelizability.

It is another object of the present invention to provide for said Convolutional Neural network (CNNs) based system and method that would overcome machine learning algorithms/analytics that have their own limitations, such that a system and method could be effectively attained giving high accuracy by circumventing the technical challenges of building a single machine learning estimator system by overcoming the challenges of (i) high variance over the input features to be learned/analyzed, (ii) low accuracy while fitting over the entire training data, along with (iii) noise and bias.

It is yet another object of the present invention to provide for said Convolutional Neural network (CNNs) based system and method that would overcome the need of embedding a single algorithm that may not make the perfect prediction for a given data set/image feature while heavily relying on too few features, but on the other hand, would allow building and combining multiple models/analytics based processor module means to permit a chance to boost the overall accuracy while ensembling to enable reduction in analytics/model error by simultaneously maintaining the generalization in performance in respect of robustness to noise.

It is still another object of the present invention to provide for said Convolutional Neural network (CNNs) based system and method that would enable ensembling based inference by combining the results preferably of ten classifiers, through majority voting driving down to select analyzable features, for an accurate demarcation of the ROI (region of interest).

It is still another object of the present invention to provide for said Convolutional Neural network (CNNs) based system and method that would also permit introduction of Focal Asymmetric Similarity (F AS) loss function based analytics to effectively handle class imbalance, for improved performance.

### SUMMARY OF THE INVENTION

Thus according to the basic aspect of the present invention there is provided a Convolutional Neural network (CNNs) based system for image analysis including for computer aided detection/diagnosis comprising:
an imaging means including a scanner means for generating image features from variety of images of subjects for required image analysis;
convolution network module including U-net image segmentation processing means and variants thereof comprising U-net framework for down- and up-sampling of the image under analysis involving encoder and decoder arms for desired semantic image segmentation;
said convolution network module adapted for semantic segmentation of the image for screening and detection/diagnosis of diseased (infected) volumes/regions from images including even complex and unknown boundaries includes deformable convolution (DC) modules, down sampling based max pooling layers, up-sampling convolution layers and basic convolution modules,
said deformable convolution (DC) module including processor for a learnable and dynamic receptive field based deformation in free form of a sampling grid involving a 2D offset generator to said sampling grid points thereby adapted to generate transformed images with precise detection and segmentation covering full regions of interest (ROI) including adaptive to the scale and shape of said ROI and based on an input image feature generating an output image feature ‘F’, corresponding to pixel location (i, j) at output channel (m) of the encoder/decoder arms of the module as per Eq. 2 below,

$${ℱ}_{i , j}^{m} = {\sum }_{c = 1}^{C} {\sum }_{p = - ⌊ K / 2 ⌋}^{⌊ K / 2 ⌋} {\sum }_{q = - ⌊ K / 2 ⌋}^{⌊ K / 2 ⌋} {ω}_{p , q}^{m} {X}_{\{ ( i + p ) + {Δ}_{x}^{( i + p )} \} , ( \{ j + q ) + {Δ}_{y}^{( j + q )} \}}^{c} \qquad ( 2 )$$

wherein Δₓ and Δ_{y} in the generated output image feature cover capture of full Region of Interests (ROI) with said Δ_{X} being offset in x-direction and Δ_{y} being offset in y-direction enabling precise detection and segmentation covering full regions of interest (ROI) even with arbitrary shapes and sizes of diseased (infected) volumes/regions of images.

Preferably in said Convolutional Neural network (CNNs) based system wherein said processor for a learnable and dynamic receptive field based deformation in free form of a sampling grid involving a 2D offset generator to generate transformed image with precise detection and segmentation covering full regions of interest (ROI) includes said Δₓ and Δ_{y} as learned offset input based pixel location shifter to enable shift in pixel position along the abscissa and ordinate respectively with said output feature ‘F’ based image map generator corresponding to said pixel location (i, j) of input image feature, generated by basic convolution module and including said Δₓ and Δ_{y} such as Δ={(Δⁿₓ, Δⁿ_{y})|1≤n≤K²} as said set of paired learnable offsets of size H×W on basic convolution operator to thus include in said output feature selectively shifted pixel location along abscissa and ordinate based on a dynamic offset value in turn enabling capture of receptive field adapted to the features of the input thus facilitating precise ROI segmentation,

with said basic convolution operator being represented by Eq. 1 below

$${ℱ}_{i , j}^{m} = {\sum }_{c = 1}^{C} {\sum }_{p = - ⌊ K / 2 ⌋}^{⌊ K / 2 ⌋} {\sum }_{q = - ⌊ K / 2 ⌋}^{⌊ K / 2 ⌋} {ω}_{p , q}^{m} {X}_{\{ i + p \} , \{ j + q \}}^{c} \qquad ( 1 )$$

where ‘c’={1, . . . , C} refers to the input channels, ‘m’={1, . . . , M} corresponding to the output channels, and K is assumed to be odd, when an input feature map X of size H×W×C is considered, where H represents the height, W corresponds to the width, and C refers to the number of input channels in basic convolution module operational based on said basic convolution operator operable preferably on a kernel size (K×K) producing an output feature map ‘F’ of size H×W×M with ‘M’ indicating the number of output channels considering ω={ωⁱ|1≤i≤M; ωⁱ∈(K×K)} is a set of learnable kernel weights of size K×K×M.

According to another preferred aspect of the present invention there is provided said Convolutional Neural network (CNNs) based system for image analysis wherein said convolution network module in its framework comprises WDU-Net (Deep Weighted Deformable Segmentation Network) comprising group of Weight generation (WG) modules/processor blocks with said Deformable Convolution (DC) modules/processor blocks for down- and up-sampling of image under analysis along said encoder and decoder arms of U-Net framework for generating weighted combination based feature maps on deformable convoluted (DC) transformed images with localization of segmented objects and/or generating highlighted boundaries thereof and related image segmentation for distinguishing objects in image which are visually similar or share common features involving dynamic assignment of importance to relevant spatial locations of the corresponding image feature including suppressing unimportant features and highlighting relevant features within said full regions of interest (ROI) generated by said deformable convolution (DC) module for advanced image segmentation.

Preferably, in said Convolutional Neural network (CNNs) based system for image analysis said WG means/modules provide for computed weighted matrix based weighted feature map generation including:
(i) computing means for basic convolution operator based on image inputs following Eq. 1

$${ℱ}_{i , j}^{m} = {\sum }_{c = 1}^{C} {\sum }_{p = - ⌊ K / 2 ⌋}^{⌊ K / 2 ⌋} {\sum }_{q = - ⌊ K / 2 ⌋}^{⌊ K / 2 ⌋} {ω}_{p , q}^{m} {X}_{\{ i + p \} , \{ j + q \}}^{c} \qquad ( 1 )$$

where ‘c’={1, . . . , C} refers to the input channels, ‘m’={1, . . . , M} corresponding to the output channels, and K is assumed to be odd, when an input feature map X of size H×W×C is considered, where H represents the height, W corresponds to the width, and C refers to the number of input channels in basic convolution module operational based on said basic convolution operator operable preferably on a kernel size (K×K) producing an output feature map ‘F’ of size H×W×M with ‘M’ indicating the number of output channels considering, ω={ωⁱ|1≤i≤M; ωⁱ∈(K×K)} is a set of learnable kernel weights of size K×K×M;
(ii) adder means for introducing said convolution operator to combine said feature maps along the encoder arm pathway with the corresponding ones at the decoder arm pathway of said U-Net following the encoder pathway to be E={Eᵢ|1≤i≤L}, where L is number of levels in the network and Eᵢ corresponds to the feature map from the encoder pathway at level I, which analogously for the decoder pathway is D={Dᵢ|1≤i≤L}, where Di is the feature map from the decoder pathway at the same level I, where (Eᵢ, Dᵢ)∈H×W×C;
(iii) weightage matrix computing means involving Sᵢ being computed as per Eq. (3) below by employing basic convolution operator of said Eqn. (1) above on both said Eᵢ and Dᵢ to reduce their channel dimensions having convᵢ^{a}=C_{1×1}(Dᵢ) and convᵢ^{b}=C_{1×1}(Eᵢ), where C_{1×1} denotes the 1×1 convolution,

$${S}_{i} = {𝒞}_{1 \times 1 \times 1} \{ ReLU ( {conv}_{i}^{a} ⊕ {conv}_{i}^{b} ) \} \qquad ( 3 )$$

and, normalized weightage matrix computing means wᵢ as given by Eq. 4 below involving sigmoid operation (σ) applied along spatial dimensions:

$${w}_{i} = σ ( {S}_{i} ) \qquad ( 4 )$$

and finally (iv) weighted feature map generator Gᵢ including computing means by element-wise multiplication ⊗ of the normalized weight matrix with the feature map Eᵢ from the encoder arm as per Eq. 5 hereunder

$${𝒢}_{i} = {w}_{i} ⊗ {E}_{i} \qquad ( 5 )$$

said weight generation computing means providing for assigning each pixel with necessary weight by suppressing unimportant features at encoding and decoding arm of the deformable convolution (DC) and generating weighted combination based feature maps on deformable convoluted (DC) transformed images with localization of segmented objects and/or generating highlighted boundaries thereof and related image segmentation for distinguishing objects in image which are visually similar or share common features involving dynamic assignment of importance to relevant spatial locations of the corresponding image feature including suppressing unimportant features and highlighting relevant features within said full regions of interest (ROI) generated by said deformable convolution (DC) module for advanced image segmentation.

According to another aspect of the present invention there is provided said Convolutional Neural network (CNNs) based system for image analysis wherein said U-net framework for down- and up-sampling of the image under analysis involving encoder and decoder arms include said weight generation (WG) and Deformable Convolution (DC) blocks processor, with said WG mechanism assigning each pixel the necessary weight during decoding of the DC enabling faster network convergence on the desired ROI and said offset and output feature generating convolution kernel means including trained feature operative sets.

Preferably in said Convolutional Neural network (CNNs) based system for image analysis said U-net framework include image patch filter means included iteration enabling disposition of max-pooling layers, convolution layers, DC block layers and up-sampling layer of the decoder generating regained final resolution of the image patch with high level semantic feature based image patch/map in the decoder concatenated through WG module for focused lower level details of feature maps of the encoder,
said WG module enabling merging of the up-sampled images with equivalent encoded representations to thereby enhance significance of a pixel and highlighting of pixels from ROI for generating relevant adaptive selection based spatial information.

According to yet another aspect of the present invention there is provided said Convolutional Neural network (CNNs) based system for image analysis wherein said weight generation (WG) module as weight segmentation mask has its gradient at each level of decoder arm in the network that includes computing means based on analytical parameter ‘θ’ for back propagating the error using the chain rule as set forth under Eq. 6 below

$$\frac{\partial {w}_{i}}{\partial θ} = \frac{\partial {ϕ}_{wgt}}{\partial {w}_{i}} \frac{\partial {f}_{dec}}{\partial {Z}_{i}} \frac{\partial {Z}_{i}}{\partial θ} + \frac{\partial {ϕ}_{wgt}}{\partial {w}_{i}} \qquad ( 6 )$$

considering the weight mask at ith level is Wᵢ, with analytic parameter θ, where a ∂ϕ_{wgt}/∂Wᵢ is the gradient of the weight generation operation w.r.t. the weighted mask, ∂f_{dec}/∂Zᵢ is the gradient of the decoder arm w.r.t. the DC block, and ∂Zᵢ/∂θ is the gradient of the DC block w.r.t. the analytic parameters, and
wherein gradient of DC block in respect of analytic parameter, at each level (i) of the encoder arm translates to

$$\frac{\partial {Z}_{i}}{\partial θ} = \frac{\partial {ϕ}_{conv}}{\partial {Z}_{i}} \frac{\partial {Z}_{i - 1}}{\partial θ} + \frac{\partial {ϕ}_{conv}}{\partial θ} \qquad ( 7 )$$

where ∂ϕ_{conv}/∂Zᵢ is the gradient of the basic convolution w.r.t. DC, and ∂ϕ_{conv}/∂θ is the gradient of convolution w.r.t. analytic parameter considering Z₀ represents input to the network, which is CT image patch.

Preferably in said Convolutional Neural network (CNNs) based system for image analysis said convolution network module framework based image segmentation means include focal asymmetric loss (FAS) based functional operator means for improved segmentation of image data with class imbalance when said ROI is small in size with respect to image background and where positive number of pixels are relatively insufficient including:

consecutive focal loss (FL) based operator means represented by Eq. 8 below:

$${L}_{f} ( p ) = - {α ( 1 - p )}^{γ} log ( p ) \qquad ( 8 )$$

considering ground truth segmentation mask (for N pixels) to be y∈{0,1}, with the corresponding predicted mask being ŷ having estimated probability p∈[0,1] with experimentally selected weighting factor α=0.7 and focusing parameter γ=2;
followed by asymmetric similarity loss (ASL) operator means that adjusts the weights between false positive (F P) and false negative (F N) (thereby, achieving a good balance between precision and recall) while training a network over highly imbalanced data, said asymmetric similarity loss operation defined as below:

$${L}_{as} ( y , p ) = \frac{( 1 + {β}^{2} ) {\sum }_{i = 1}^{N} {p}_{i} {y}_{i}}{( 1 + {β}^{2} ) {\sum }_{i = 1}^{N} {p}_{i} {y}_{i} + {β}^{2} {\sum }_{i = 1}^{N} ( 1 - {p}_{i} ) {y}_{i} + {\sum }_{i = 1}^{N} {p}_{i} ( 1 - {y}_{i} )} \qquad ( 9 )$$

and applying adder means for combination of merits of loss functions of Eqns. (8)-(9) as the new Focal asymmetric loss (FAS) for improved segmentation of highly imbalanced data, with the ROI being very small in size with respect to the background region definable as

$${L}_{fas} = λ {L}_{as} + ( 1 - λ ) {L}_{f} \qquad ( 10 )$$

$$⇒ {L}_{fas} = \frac{λ ( 1 + {β}^{2} ) {\sum }_{i = 1}^{N} {p}_{i} {y}_{i}}{( 1 + {β}^{2} ) {\sum }_{i = 1}^{N} {p}_{i} {y}_{i} + {β}^{2} {\sum }_{i = 1}^{N} ( 1 - {p}_{i} ) {y}_{i} + {\sum }_{i = 1}^{N} {p}_{i} ( 1 - {y}_{i} )} - α ( 1 - λ ) {( 1 - p )}^{γ} log ( p )$$

considering hyper-parameter λ=0.65.

According to another preferred aspect of the present invention there is provided said Convolutional Neural network (CNNs) based system for image analysis wherein said 2D offset generator include pair of learnable offsets for DC which are pair of learnable offsets for DC are derived by applying convolutional layer over the same input feature map with the spatial resolution and dilation of the convolution kernel being identical to those of the current convolutional layer with the spatial resolution of the output offset field matching with that of the corresponding input feature map, with the channel dimension 2N equivalent to N×2D offsets, with both the offsets and output feature-generating convolution kernels being concurrently obtained during automated analysis.

More preferably in said Convolutional Neural network (CNNs) based system for image analysis wherein the convolution network module comprises nine numbers of convolution processor blocks, four max-pooling layers, four up-sampling convolution layers, and eight deformable convolution (DC) blocks to operate on input CT image patch of size 128×128 pixels fed at the input, with stride of 1 filtering the patches through four sets of iterations at encoder arm of DC encompassing 2×2 down-sampling based max-pooling layers, 3×3 basic convolution layers, and deformable convolution (DC) block layers, with 2×2 up-sampling layers at the decoder arm aiding in regaining final resolution of the image(s).

According to another preferred aspect of the present invention there is provided said Convolutional Neural network (CNNs) based system for image analysis wherein in said convolution module said DC processor blocks are included in the first four down-sampling based max-pooling encoder layers and the final four up-sampling decoder layers for gathering ROI-specific data, to lower overlap based error at the segmentation boundary while increasing the accuracy of segmentation and to enable storage of high-level semantic feature based image maps in the decoder;
said WG module processor blocks interactive with DC blocks concatenates said high-level semantic feature based image maps stored in the up-sampled decoder arm of DC blocks to focus on the lower-level details in the retrieved encoder feature maps of DC blocks for merging of said up-sampled images with their equivalent encoded representations thereby enhancing significance/weightage of a pixel through said WG module allowing adaptive selection of pixel spatial information by highlighting pixels from the ROI, while suppressing the less important ones, with said last layer of WDU-Net (Deep Weighted Deformable Segmentation Network) involving sigmoid activation function based processer to generate a probabilistic ROI at the system output, as per the block based system architecture below:

| | | | | | | Weight Generation (WG) block | | | |
|---|---|---|---|---|---|---|---|---|---|
| | | | | (Kernel | # | | | Kernel | # |
| Block | Input | (size) | Layer | Size) | Kernels | Input | Layer | Size | Kernels |
| | Input: | (128*128*1) | | | | ConvX | WGZ | (3*3) | n |
| 1 | CT | (128*128*1) | DC1 | (3*3) | 16 | Deform- | | | |
| | image | | | | | BlockY | | | |
| | Deform- | (128*128*16) | conv1 | (3*3) | 16 | Deform- | conv^{a} | (1*1) | n |
| | Out1 | | | | | BlockY | | | |
| | conv1 | (128*128*16) | maxpooling1 | (2*2) | 16 | convX | conv^{b} | (1*1) | n |
| 2 | maxpooling1 | (64*64*16) | DC2 | (3*3) | 32 | conv^{a} | Add | | |
| | Deform- | (64*64*32) | conv2 | (3*3) | 32 | conv^{b} | | | |
| | Out2 | | | | | Add | ReLU | | |
| | conv2 | (64*64*32) | maxpooling2 | (2*2) | 32 | | activation | | |
| 3 | maxpooling2 | (32*32*32) | DC3 | (3*3) | 64 | ReLU | S | (1*1) | 1 |
| | Deform- | (32*32*64) | conv3 | (3*3) | 64 | activation | | | |
| | Out3 | | | | | S | Sigmoid | | |
| | conv3 | (32*32*64) | maxpooling3 | (2*2) | 64 | | Activation | | |
| 4 | maxpooling3 | (16*16*64) | DC4 | (3*3) | 128 | | (SA) | | |
| | Deform- | (16*16*128) | conv4 | (3*3) | 128 | convX | MultiplyZ | | |
| | Layer | | | | | SA | | | |
| | Out4 | (16*16*128) | maxpooling4 | (2*2) | 128 | Deformation Convolution (DC) | | | |
| | conv4 | | | | | LayerM | DCZ | (3*3) | n |
| 5 | maxpooling4 | (8*8*128) | conv5 | (3*3) | 256 | LayerM | conv^{d} | (3*3) | n |
| | conv5 | (8*8*256) | conv6 | (3*3) | 256 | | Δ = 2D | | |
| | conv6 | (8*8*256) | Upsampling1 | (2*2) | 256 | | offsets | | |
| 6 | Upsampling1 | (16*16*256) | DC5 | (3*3) | 128 | | (Δx, Δy), | | |
| | conv4 | (16*16*128) | WG1 | | 128 | | ω = Learned | | |
| | Deform- | (16*16*128) | | | | | Kernel | | |
| | Out5 | | | | | | weights, | | |
| | Upsampling1 | (16*16*256) | concat1 | | 384 | | Deform- | | |
| | Multiply1 | (16*16*128) | | | | | OutZ = | | |
| | concat1 | (16*16*384) | conv7 | (3*3) | 128 | | ω* | | |
| | conv7 | (16*16*128) | Upsampling2 | (2*2) | 128 | | conv^{d} Δ | | |
| 7 | Upsampling2 | (32*32*128) | DC6 | (3*3) | 64 | | | | |
| | conv3 | (32*32*64) | WG2 | | 64 | | | | |
| | Deform- | (32*32*64) | | | | | | | |
| | Out6 | | | | | | | | |
| | Upsampling2 | (32*32*128) | concat2 | | 192 | | | | |
| | Multiply2 | (32*32*64) | | | | | | | |
| | concat2 | (32*32*192) | conv8 | (3*3) | 64 | | | | |
| | conv8 | (32*32*64) | Upsampling3 | (2*2) | 64 | | | | |
| 8 | Upsampling3 | (64*64*64) | DC7 | (3*3) | 32 | | | | |
| | conv2 | (64*64*32) | WG3 | | 32 | | | | |
| | Deform- | (64*64*32) | | | | | | | |
| | Out7 | | | | | | | | |
| | Upsampling3 | (64*64*64 | concat3 | | 96 | | | | |
| | Multiply3 | (64*64*32) | | | | | | | |
| | concat3 | (64*64*96) | conv9 | (3*3) | 32 | | | | |
| | conv9 | (64*64*32) | Upsampling4 | (2*2) | 32 | | | | |
| | | Upsampling4 | | (3*3) | 16 | | | | |
| (128*128*32) | | DC8 | | | | | | | |
| | conv1 | (128*128*16) | WG4 | | 16 | | | | |
| | Deform- | (128*128*16) | | | | | | | |
| | Out8 | | | | | | | | |
| 9 | Upsampling4 | (128*128*32) | concat4 | | 48 | | | | |
| | Multiply4 | (128*128*16) | | | | | | | |
| | concat4 | (128*128*48) | conv10 | (3*3) | 16 | | | | |
| | conv10 | (128*128*16) | conv11 | (1*1) | 1 | | | | |
| | conv11 | (128*128*1) | Sigmoid | | 1 | | | | |
| | | | activation | | | | | | |
| | Output: | (128*128*1) | | | | | | | |

More preferably in said Convolutional Neural network (CNNs) based system for image analysis wherein said WDU-Net (Deep Weighted Deformable Segmentation Network) based system architecture is adapted for accurate segmentation based detection of altered object image/diseased or infected volumes from medical images involving diverse image modalities including CT, MRI, PET, MRS, SPECT.

According to another preferred aspect of the present invention there is provided said Convolutional Neural network (CNNs) based system for image analysis wherein said WDU-Net (Deep Weighted Deformable Segmentation Network) based system architecture include means for (a) DC module capturing unknown geometric shape of tumor/diseased region, assisted by said WG module for suppressing unimportant features and highlighting the relevant ones, (b) FAS loss function involving a judicious combination of the Focal loss and Asymmetric Similarity loss that enabled effective determination of class imbalance, (c) training/iteration on various image patches for aiding improved and balanced learning by combining the outputs of ensembled classifiers by considering the similarity in major outputs, thereby adding to performance enhancement of image inference while arriving at a proper decision regarding the segmentation of ROI.

Preferably in said Convolutional Neural network (CNNs) based system for image analysis and having WDU-Net (Deep Weighted Deformable Segmentation Network) based system architecture wherein

said imaging means include CT, MRI, PET, MRS, SPECT scanner based imaging means to generate predetermined image informative features;
said convolution network module includes:
(i) memory storage-cum-image processor means to support said predetermined representative image informative features, and process the same for sharing said features with detector-cum-image processor means incorporating deformable convolution (DC) module based processors and/or weight generation (WG) module based processors and/or focal loss module based processors, with said image detector processor modules processing for an area of consolidation by ablating representative image features post applying deformable convolution (DC) processing and/or weight generation (WG) processing to enable feature extraction and related image re-construction for efficiently demarcating and accurately segmenting subtle changes in medical images of objects/tissues;
(ii) display means to display demarcated and accurately segmented medical images including of altered object/diseased tissue volumes of arbitrary shapes and sizes by preferentially overcoming class imbalance in representative image features; and
(iii) processor means in operative connection for image supporting data acquisition, processing, detection and display.

More preferably in said Convolutional Neural network (CNNs) based system for image analysis wherein the system includes trained image datasets of subjects from said scanner means including selected from CT, MRI, PET, MRS, SPECT images with preserved pixel values of medical images.

According to another aspect of the present invention a method for efficient image segmentation focusing on Region of Interest (ROI) of varying shapes and sizes involving said system is provided comprising:
carrying out convolution network module based semantic image segmentation through said processor means including U-net image segmentation means and variants thereof comprising U-net framework for down- and up-sampling of the image under analysis involving encoder and decoder arms for desired semantic image segmentation including:
following steps of deformable convolution in deformable convolution (DC) modules for a learnable and dynamic receptive field based deformation in free form of a sampling grid involving a 2D offset generator to said sampling grid points, down sampling based max pooling layers, up-sampling convolution layers and basic convolution modules for generating transformed images with precise detection and segmentation covering full regions of interest (ROI) including adaptive to the scale and shape of said ROI and based on input image feature generating an output image feature ‘F’, corresponding to pixel location (i, j) at output channel (m) of the encoder/decoder arms of the module as per Eq. 2 below,

$${ℱ}_{i , j}^{m} = {\sum }_{c = 1}^{C} {\sum }_{p = - ⌊ K / 2 ⌋}^{⌊ K / 2 ⌋} {\sum }_{q = - ⌊ K / 2 ⌋}^{⌊ K / 2 ⌋} {ω}_{p , q}^{m} {X}_{\{ ( i + p ) + {Δ}_{x}^{( i + p )} \} , ( \{ j + q ) + {Δ}_{y}^{( j + q )} \}}^{c} \qquad ( 2 )$$

wherein Δₓ and Δ_{y} in the generated output image feature cover capture of full Region of Interests (ROI) with said Δₓ being offset in x-direction and Δ_{y} being offset in y-direction enabling precise detection and segmentation covering full regions of interest (ROI) even with arbitrary shapes and sizes of diseased (infected) volumes/regions of images.

Preferably in said method said step of deformable convolution in said DC module generates transformed image with precise detection and segmentation covering full regions of interest (ROI) involving said Δx and Δy as learned offset input parameter based pixel location shifting, to enable shift in pixel position along the abscissa and ordinate respectively generating said output feature ‘F’ based on image map generator corresponding to said pixel location (i, j) of input image feature generated by basic convolution module and including said Δₓ and Δ_{y} such as Δ={(Δⁿₓ, Δⁿ_{y})|1≤n≤K²} as said set of paired learnable offsets of size H×W on basic convolution operator to thus include in said output feature selectively shifted pixel location along abscissa and ordinate based on a dynamic offset value in turn enabling capture of receptive field adapted to the features of the input thus facilitating precise ROI segmentation,

with said basic convolution operator is as represented by Eq. 1 below

$${ℱ}_{i , j}^{m} = {\sum }_{c = 1}^{C} {\sum }_{p = - ⌊ K / 2 ⌋}^{⌊ K / 2 ⌋} {\sum }_{q = - ⌊ K / 2 ⌋}^{⌊ K / 2 ⌋} {ω}_{p , q}^{m} {X}_{\{ i + p \} , \{ j + q \}}^{c} \qquad ( 1 )$$

where ‘c’={1, . . . , C} refers to the input channels, ‘m’={1, . . . , M} corresponding to the output channels, and K is assumed to be odd, when an input feature map X of size H×W×C is considered, where H represents the height, W corresponds to the width, and C refers to the number of input channels in basic convolution module operational based on said basic convolution operator operable preferably on a kernel size (K×K) producing an output feature map ‘F’ of size H×W×M with ‘M’ indicating the number of output channels considering, ω={ωⁱ|1≤i≤M; ωⁱ∈(K×K)} is a set of learnable kernel weights of size K×K×M.

According to another preferred aspect of the method the same comprises involving WDU-Net (Deep Weighted Deformable Segmentation Network) comprising group of Weight generation (WG) modules/blocks operative with said Deformable Convolution (DC) modules/blocks along said encoder and decoder arms of U-Net framework for generating weighted combination based feature maps on deformable convoluted (DC) transformed images with localization of segmented objects and/or generating highlighted boundaries thereof and related image segmentation for distinguishing objects in image which are visually similar or share common features involving dynamic assignment of importance to relevant spatial locations of the corresponding image feature including suppressing unimportant features and highlighting relevant features within said full regions of interest (ROI) generated by said deformable convolution (DC) module for advanced image segmentation.

Preferably in said method wherein said step of weight generation involving said WG means/modules providing for computed weighted matrix based weighted feature map generation including:
(i) computing for basic convolution operator based on image inputs following Eq. 1

$${ℱ}_{i , j}^{m} = {\sum }_{c = 1}^{C} {\sum }_{p = - ⌊ K / 2 ⌋}^{⌊ K / 2 ⌋} {\sum }_{q = - ⌊ K / 2 ⌋}^{⌊ K / 2 ⌋} {ω}_{p , q}^{m} {X}_{\{ i + p \} , \{ j + q \}}^{c} \qquad ( 1 )$$

where ‘c’={1, . . . , C} refers to the input channels, ‘m’={1, . . . , M} corresponding to the output channels, and K is assumed to be odd, when an input feature map X of size H×W×C is considered, where H represents the height, W corresponds to the width, and C refers to the number of input channels in basic convolution module operational based on said basic convolution operator operable preferably on a kernel size (K×K) producing an output feature map ‘F’ of size H×W×M with ‘M’ indicating the number of output channels considering, ω={ωⁱ|1≤i≤M; ωⁱ∈(K×K)} is a set of learnable kernel weights of size K×K×M;
(ii) adding/introducing said convolution operator to combine said feature maps along the encoder arm pathway with the corresponding ones at the decoder arm pathway of said U-Net following the encoder pathway to be E={Eᵢ|1≤i≤L}, where L is number of levels in the network and Eᵢ corresponds to the feature map from the encoder pathway at level I, which analogously for the decoder pathway is D={Dᵢ|1≤i≤L}, where Dᵢ is the feature map from the decoder pathway at the same level I, where (Eᵢ, Dᵢ)∈H×W×C;
(iii) involving weightage matrix Sᵢ to be computed as per Eq. (3) below by employing basic convolution operator of said Eqn. (1) above on both said Eᵢ and Dᵢ to reduce their channel dimensions having convᵢ^{a}=C_{1×1}(Dᵢ) and convᵢ^{b}=C_{1×1}(Eᵢ), where C_{1×1} denotes the 1×1 convolution,

$${S}_{i} = {𝒞}_{1 \times 1 \times 1} \{ ReLu ( {conv}_{i}^{a} ⊕ {conv}_{i}^{b} ) \} \qquad ( 3 )$$

and, normalized weightage matrix computing means wᵢ as given by Eq. 4 below involving sigmoid operation (σ) applied along spatial dimensions:

$${w}_{i} = σ ( {S}_{i} ) \qquad ( 4 )$$

and finally (iv) generating weighted feature map Gᵢ involving computing means by element-wise multiplication ⊗ of the normalized weight matrix with the feature map Eᵢ from the encoder arm as per Eq. 5 hereunder

$${𝒢}_{i} = {w}_{i} ⊗ {E}_{i} \qquad ( 5 )$$

said weight generation computing means providing for assigning each pixel with necessary weight by suppressing unimportant features at encoding and decoding arm of the deformable convolution (DC) and generating weighted combination based feature maps on deformable convoluted (DC) transformed images with localization of segmented objects and/or generating highlighted boundaries thereof and related image segmentation for distinguishing objects in image which are visually similar or share common features involving dynamic assignment of importance to relevant spatial locations of the corresponding image feature including suppressing unimportant features and highlighting relevant features within said full regions of interest (ROI) generated by said deformable convolution (DC) module for advanced image segmentation.

According to another preferred aspect of said method said efficient image segmentation is by focusing on Region of Interest (ROI) of varying shapes and sizes and said steps of basic convolution operations, deformable convolution and Weight generation (WG) are based on trained image datasets including subjects from said diverse image scanners selected from CT, MRI, PET, MRS, SPECT images.

### BRIEF DESCRIPTION OF FIGURES

The patent or application file contains at least one drawing executed in color. Copies of this patent or patent application publication with color drawing(s) will be provided by the Office upon request and payment of the necessary fee.

FIG. 1: Schematic diagram of the entire procedure;

FIG. 2a: Illustration of sampling locations, as modeled in basic and deformable convolution;

FIG. 2b: Block-level illustration of the model showing block-level architecture with extracted features;

FIG. 3a-3c: The WDU-Net framework, with detailed representation of Weight Generation (W G), and Deformable Convolution (DC) blocks;

FIG. 3d: Comparative performance on unseen test data, using ensembling with FAS loss;

FIG. 4: Effect of introducing Deformable Convolution (DC) module at Block 9 (of Table 2) on the feature maps generated at different stages of training of the WDU-Net;

FIG. 5: Feature maps generated with and without incorporating the WG modules;

FIG. 6: Comparative study on sample slices from the test datasets, using different models, with corresponding DSC being inscribed on each slice. (a) Original CT scan, with (b) Annotated masks. Segmentation obtained by (c) U-Net, (d) Attention U-Net, (e) DU-Net (without WG), and (f) WDU-Net, with regions indicating Green: True Positive, Red: False Negative, Yellow: False Positive

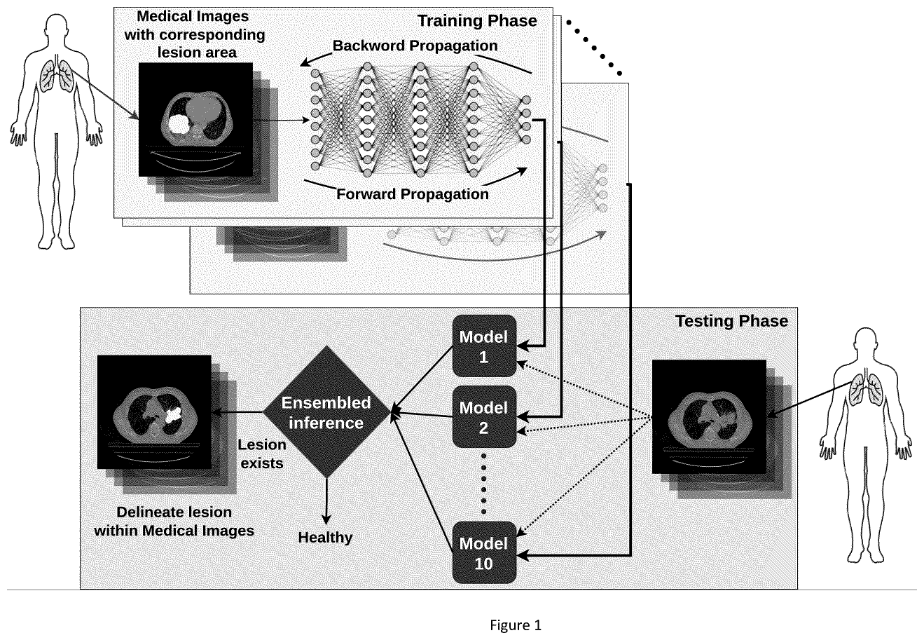

### DETAILED DESCRIPTION OF THE INVENTION

As discussed hereinbefore, the present invention provides for a Convolutional Neural network (CNNs) based system and method based on the same for image analysis including for computer aided detection/diagnosis enabling an efficient and accurate delineation of diseased volumes in images/medical images. The system of the present invention is thus adapted to incorporate deformable convolution (DC) module based processor means, along the down- and up-sampling pathways of the underlying U-Net architectural framework of said system for effective understanding and attending to deformable geometry of unknown transformations, considering deformable convolution (DC), unlike the basic convolution is advantageously not constrained by predefined geometrical structures of the kernels. Said system of the present invention advantageously also permits weighted combination of image feature components along the encoder and decoder arms of the deformable convolution (DC) processor module based system architectural network due to introduction of Weight Generation (WG) modules in said system, such that dynamic assignment of importance to relevant spatial locations of the corresponding image feature maps could be given so as to also boost overall accuracy while ensembling to enable reduction in module analytic error by simultaneously maintaining the generalization in performance in respect of robustness to noise to attain accurate and faster demarcation of the ROI (region of interest). Added to the aforesaid, preferred integration of analytic Focal Asymmetric Similarity (F AS) loss function based processor module/means in said system, allowed effective handling of class imbalance for further improved performance.

The deformable convolution (DC) based processor means of the present system can replicate a learnable/analyzable and dynamic receptive field, by allowing the sampling grid to be deformed in free form through the addition of 2D offsets to the grid sampling points of an ordinary convolution. Additional convolution layers are employed in said system to understand/learn the offsets from the preceding image feature maps. As a result, the deformation is local, dense, and adaptively conditioned on the input image feature attributes. The DC has the benefit of an adaptive receptive field, which could be read/learned from the data and varies according to the scale and shape of the object (ROI). Weighted combination of components introduced and applied along the encoder and decoder arms of the deformable convolution (DC) processor module based system architectural network, due to preferred introduction/incorporation of Weight Generation (WG) processor module means, enables dynamic assignment of importance to relevant spatial locations of the corresponding image feature maps. It helps minimize the time complexity in conventional deep models, while enhancing interpretability and parallelizability. Ensembling enables reduction in module processor error, while simultaneously maintaining the generalization in performance with robustness to noise, with ensembled inferencing being involved to combine the results of classifiers preferably ten classifiers, through majority voting acceptance, for an accurate demarcation of the ROI. Analytic Focal Asymmetric Similarity (F AS) loss function based processor module/means effectively handle class imbalance, for improved performance.

TABLE 1
Six publicly available datasets

| Sr. | Dataset | Total patients | Used For |
|---|---|---|---|
| 1 | NSCLC radiomics^{a}: | 263 | Training |
| 2 | NSCLC radiogenomics^{b} | 89 | Testing |
| 3 | Decathlon^{c} | 63 | Testing |
| 4 | LIDC-IDRI^{d} | 875 | Testing |
| 5 | Moffitt^{e} | 440 | Testing |
| 6 | Rider^{f} | 31 | Testing |

^{a}NSCLC radiomics:
https://wiki.cancerimagingarchi [symbol] e.net/display/Public/NSCLC-Radiomics [23], (accessed Mar. 1, 2023)
^{b}NSCLC radiogenomics:
https://wiki.cancerimagingarchi [symbol] e.net/display/Public/NSCLC+Radiogenomics [24], (accessed Mar. 1, 2023)
^{c}Decathlon:
https://dri [symbol] e.google.com/dri [symbol] e/folders/1HqEgzS8BV2c7xYNrZdEAnrHk7osJJ--2 [25], (accessed Mar. 1, 2023)
^{d}LIDC-IDRI:
https://wiki.cancerimagingarchi [symbol] e.net/pages/iewpage.action?pageId=1966254 [26], (accessed Mar. 1, 2023)
^{e}Moffitt: [27], (accessed Mar. 1, 2023)
^{f}Rider:
https://wiki.cancerimagingarchi [symbol] e.net/display/Public/RIDER+Lung+CT [28], (accessed Mar. 1, 2023)

Six publicly available datasets were used in the implementation. These are NSCLC radiomics, NSCLC radiogenomics, Decathlon, LIDC-IDRI, Moffitt and Rider, as outlined in Table 1. This was followed by data preparation for training and testing. The performance of WDU-Net was evaluated on the five test datasets, which were obtained from different sources and were not used during the training. This criterion justifies the generalization capability of the present invention. The effectiveness of the network was validated through ablation studies, along with comparison with state-of-the-art methods over multiple diverse datasets using several performance metrics (Table 6).

a. Basic Essential and Preferred Features and their Relevance in the System:

Computerized detection and prognosis of lung cancer is typically based on computer tomography (CT) image analysis, whereby the region of interest (ROI) is accurately demarcated and classified. Deep Learning in computer vision provides a different perspective to image segmentation. Due to the increasing number of lung cancer cases and the availability of huge volumes of CT scans every day, the need for automated handling becomes imperative. This calls for efficient detection and diagnosis, through the design of new techniques for enhanced accuracy. In this invention we introduce the novel deep Weighted Deformable segmentation network (WDU-Net) for efficient delineation of the tumor region. The Deformable Convolution (DC) can model arbitrary geometric shapes of ROIs. This is augmented by the Weight Generation (WG) module for suppressing unimportant features while highlighting the relevant ones. A unique and new Focal Asymmetric Similarity (F AS) loss function helps handle class imbalance. Ablation studies and comparison with state-of-the-art models help establish the effectiveness of WDU-Net, with ensembled inferencing, over five publicly available lung cancer datasets. It achieved an AUC of 94.49% on the LIDC-IDRI Lung Tumor data.

The deformable convolution operation was mathematically formulated. Given an input feature map X of size H×W×C, where H represents the height, W corresponds to the width, and C refers to the number of input channels, the basic convolution operation (with a kernel size of K×K) produces an output feature map F of size H×W×M, with M indicating the number of output channels. Let ω={ωⁱ|1≤i≤M; ωⁱ∈(K×K)} be the set of learnable kernel weights of size K×K×M. The output feature F, corresponding to pixel location (i, j) and output channel m, is computed as

$${ℱ}_{i , j}^{m} = {\sum }_{c = 1}^{C} {\sum }_{p = - ⌊ K / 2 ⌋}^{⌊ K / 2 ⌋} {\sum }_{q = - ⌊ K / 2 ⌋}^{⌊ K / 2 ⌋} {ω}_{p , q}^{m} {X}_{\{ i + p \} , \{ j + q \}}^{c} \qquad ( 1 )$$

where c={1, . . . , C} refers to the input channels, m={1, . . . , M} corresponds to the output channels, and K is assumed to be odd.

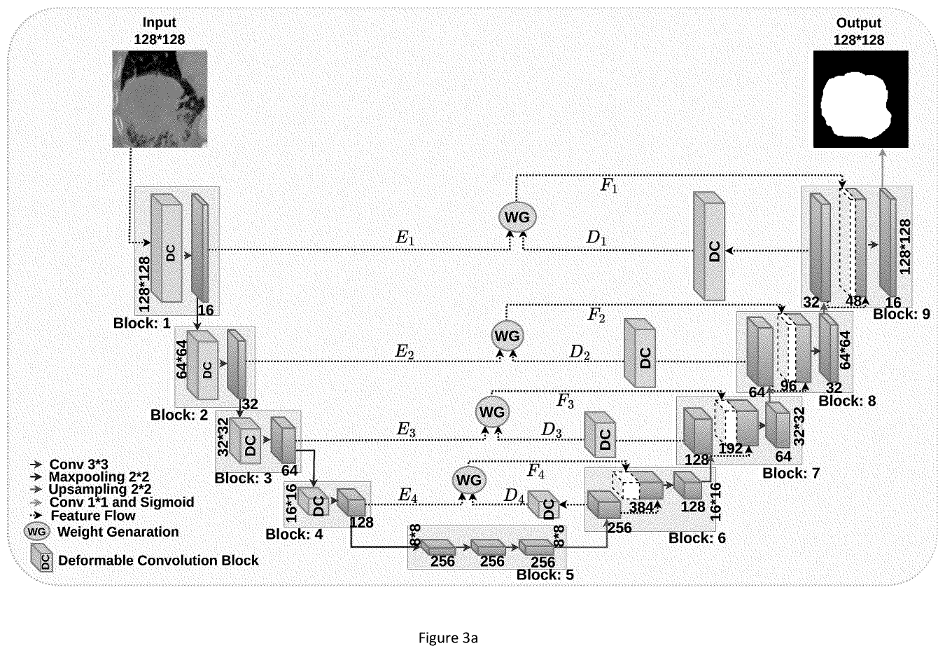

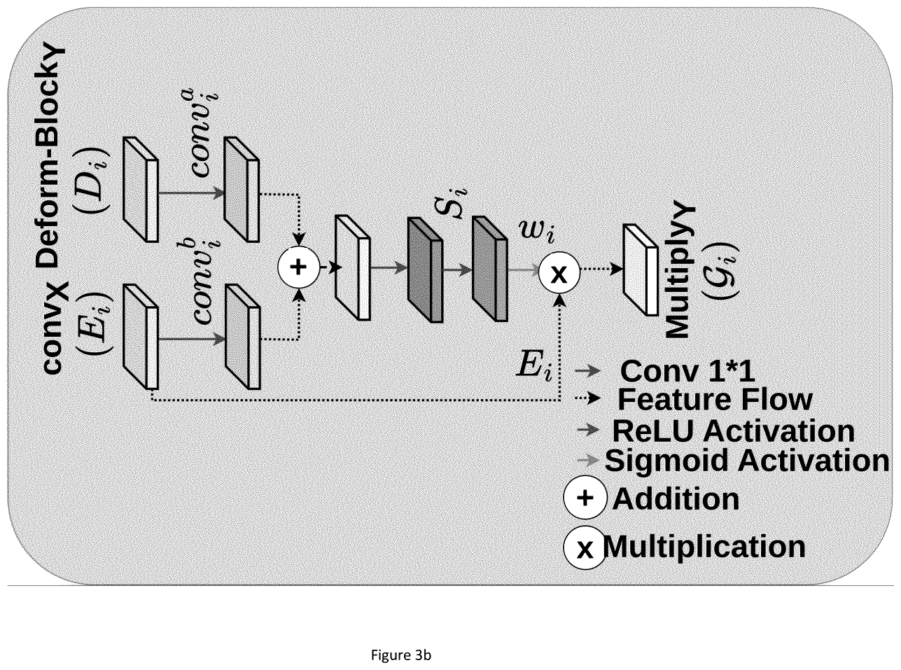

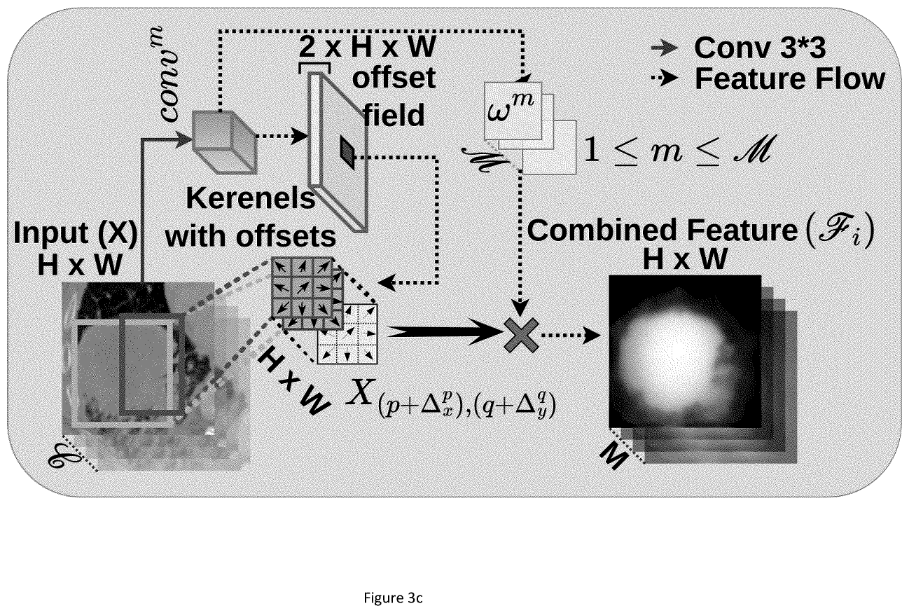

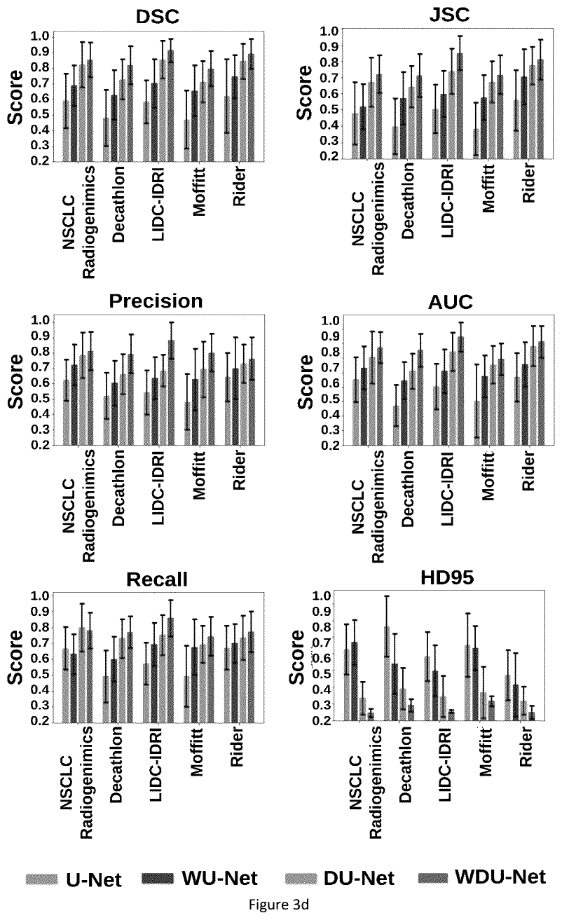

Now if Δ={(Δⁿₓ, Δⁿ_{y})|1≤n≤K²} is the set of paired learnable offsets of size H×W for deformable convolution (DC). The schematic representation of the DC module is presented in FIG. 3(c). The output feature F, corresponding to pixel location (i, j) and output channel m, now becomes

$${ℱ}_{i , j}^{m} = {\sum }_{c = 1}^{C} {\sum }_{p = - ⌊ K / 2 ⌋}^{⌊ K / 2 ⌋} {\sum }_{q = - ⌊ K / 2 ⌋}^{⌊ K / 2 ⌋} {ω}_{p , q}^{m} {X}_{\{ ( i + p ) + {Δ}_{x}^{( i + p )} \} , ( \{ j + q ) + {Δ}_{y}^{( j + q )} \}}^{c} \qquad ( 2 )$$

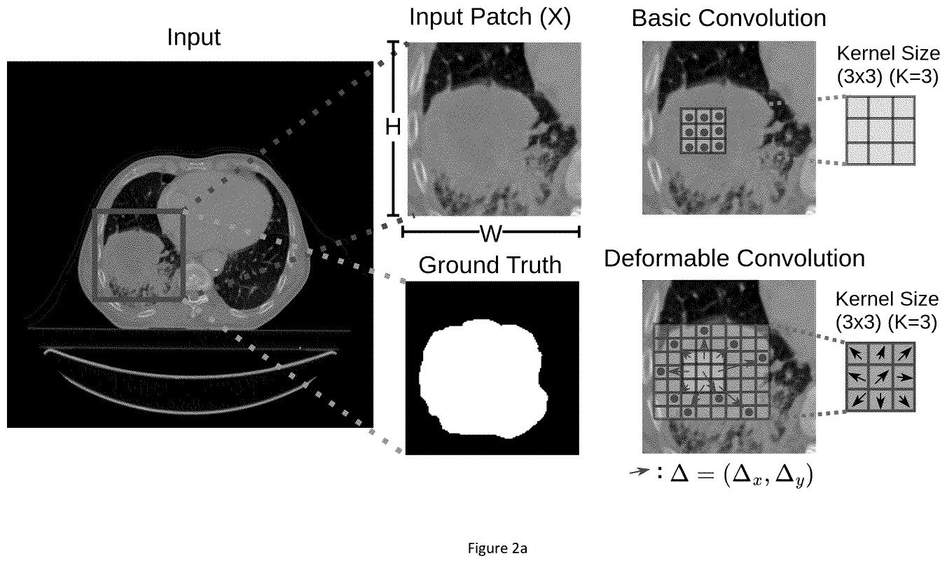

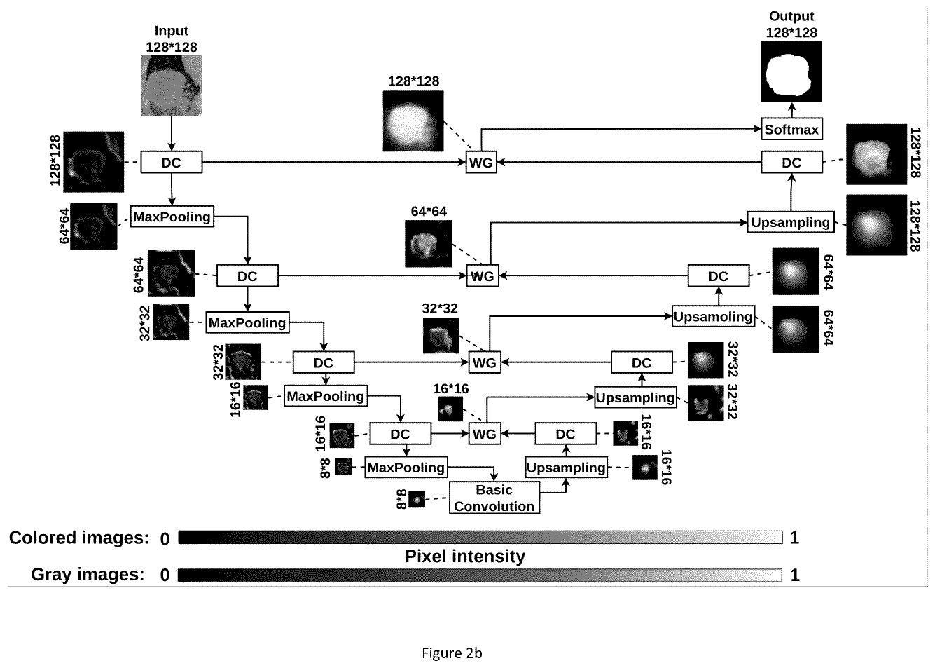

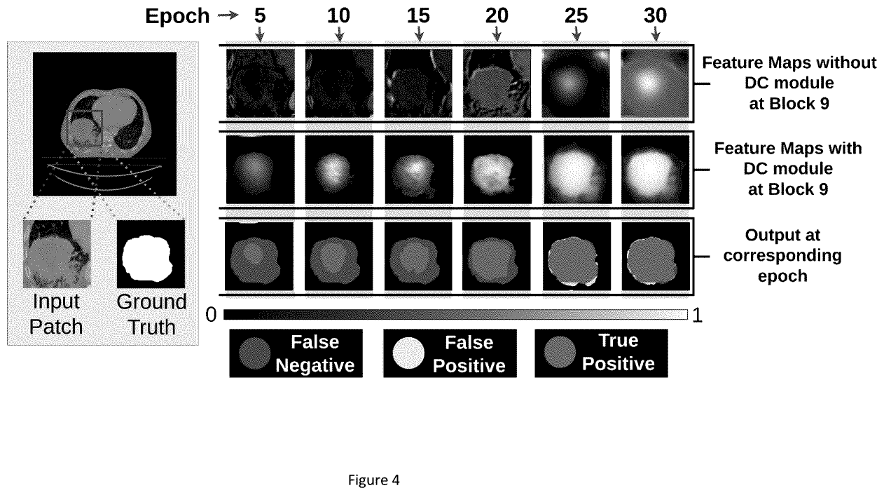

As observed from FIG. 2a, here Δx and Δy are the learned offsets. They represent the amount by which the position of the pixel location can be shifted along the abscissa and ordinate, respectively. Thus the DC allows the receptive field of the network to adapt to the features of the input. This can be particularly useful for tasks such as object detection and segmentation, where the objects of interest may have arbitrary shapes and sizes. The DC blocks are incorporated in the WDU-Net architecture of FIG. 3 (green blocks) for better modeling of different geometric shapes of the tumor region(s). This can be validated from the results depicted in FIG. 4.

The weight generation (WG) modules are introduced for a weighted combination of feature maps along the encoder pathway with the corresponding ones in the decoder pathway. Let E={Eᵢ|1≤i≤L}, where L is number of levels in the network and Eᵢ corresponds to the feature map from the encoder pathway at level i. Analogously, for the decoder pathway we have D={Dᵢ|1≤i≤L}, where Dᵢ is the feature map from the decoder pathway at the same level i. We have (Eᵢ, Dᵢ)∈H×W×C.

The new and unique WG module employs the convolution operator of eqn. (1) on both Eᵢ and Dᵢ to reduce their channel dimensions. The W G module structure is elaborated in FIG. 3(b), in the global framework of the WDU-Net architecture of FIG. 3(a). Having convᵢ^{a}=C_{1×1}(Dᵢ) and conv^{b}ᵢ=C_{1×1}(Eᵢ), where C_{1×1} denotes the 1×1 convolution, the weightage matrix is computed as

$${S}_{i} = {𝒞}_{1 \times 1 \times 1} \{ ReLu ( {conv}_{i}^{a} ⊕ {conv}_{i}^{b} ) \} \qquad ( 3 )$$

Here C_{1×1×1} denotes a 1×1×1 convolution, and ⊕ is element-wise addition. The normalized weightage matrix becomes

$${w}_{i} = σ ( {S}_{i} ) \qquad ( 4 )$$

with a sigmoid operation (σ) being applied along the spatial dimensions. The weighted feature map Gᵢ is computed by element-wise multiplication ⊗ of the normalized weight matrix with the feature map Eᵢ from the encoder pathway. We have

$${𝒢}_{i} = {w}_{i} ⊗ {E}_{i} \qquad ( 5 )$$

The unique architecture of the WDU-Net is composed of a group of Weight Generation (WG) and Deformable Convolution (DC) blocks, which are placed along the encoding and decoding arms of the U-Net framework. The architecture of the invention is illustrated in FIG. 3. The segmentation performance gets enhanced and is robust to generalization through the use of the DC blocks in lieu of conventional down and/or up-sampling. The W G mechanism of FIG. 3(b) assigns each pixel the necessary weight during decoding of the DC in FIG. 3(c).

The offsets of the DC are derived by applying a convolutional layer over the same input feature map, as shown in FIG. 3(c). The spatial resolution and dilation of the convolution kernel are identical to those of the current convolutional layer [ie., also 3×3 with dilation 1 in FIG. 3(c)]. The spatial resolution of the output offset field matches with that of the corresponding input feature map. The channel dimension 2N is equivalent to N×2D offsets. Both the offsets and output feature-generating convolution kernels are concurrently learned during training.

The gradient of the predicted segmentation mask is computed w.r.t. the model parameters, by back propagating the error using the chain rule. Let the weight mask at the ith level be Wᵢ, with model parameters θ. The gradient of the weight mask, at each level of the decoder network, is given by

$$\frac{\partial {w}_{i}}{\partial θ} = \frac{\partial {ϕ}_{wgt}}{\partial {w}_{i}} \frac{\partial {f}_{dec}}{\partial {Z}_{i}} \frac{\partial {Z}_{i}}{\partial θ} + \frac{\partial {ϕ}_{wgt}}{\partial {w}_{i}} \qquad ( 6 )$$

where ∂ϕ_{wgt} ∂Wᵢ is the gradient of the weight generation operation w.r.t. the weighted mask, ∂f_{dec} ∂Zᵢ is the gradient of the decoder block w.r.t. the DC block, and ∂Zᵢ ∂θ is the gradient of the DC block w.r.t. the model parameters. The gradient of the DC block w.r.t. the model parameters, at each level (i) of the encoder network, becomes

$$\frac{\partial {Z}_{i}}{\partial θ} = \frac{\partial {ϕ}_{conv}}{\partial {Z}_{i}} \frac{\partial {Z}_{i - 1}}{\partial θ} + \frac{\partial {ϕ}_{conv}}{\partial θ} \qquad ( 7 )$$

where ∂ϕ_{conv} ∂Zᵢ is the gradient of the basic convolution w.r.t. DC, and ∂ϕ_{conv} ∂θ is the gradient of convolution w.r.t. model parameters. Here Z₀ represents the input to the model, which is the CT image patch.
B. Identification of Optional Features and their Relevance in the System:

The other unique and new feature introduced is the Focal Asymmetric Loss function (F AS). Let the ground truth segmentation mask (for N pixels) be y∈{0,1}, with the corresponding predicted mask being ŷ having estimated probability p∈[0,1]. The focal loss (F L) [29] overcomes class imbalance in datasets, where positive number of pixels are relatively insufficient. It is defined as

$${L}_{f} ( p ) = - {α ( 1 - p )}^{γ} log ( p ) \qquad ( 8 )$$

with the weighting factor α=0.7 and focusing parameter γ=2 being selected experimentally. The asymmetric similarity loss (ASL) [30] adjusts the weights between false positive (F P) and false negative (F N) (thereby, achieving a good balance between precision and recall) while training a network over highly imbalanced data. Asymmetric similarity loss is defined as

$${L}_{as} ( y , p ) = \frac{( 1 + {β}^{2} ) {\sum }_{i = 1}^{N} {p}_{i} {y}_{i}}{( 1 + {β}^{2} ) {\sum }_{i = 1}^{N} {p}_{i} {y}_{i} + {β}^{2} {\sum }_{i = 1}^{N} ( 1 - {p}_{i} ) {y}_{i} + {\sum }_{i = 1}^{N} {p}_{i} ( 1 - {y}_{i} )} \qquad ( 9 )$$

with the choice of hyper-parameter β=1.5 being made after several experiments. The merits of the loss functions of egns. (8)-(9) are combined as the new Focal asymmetric loss (F AS) for improved segmentation of highly imbalanced data, with the ROI being very small in size with respect to the background region. This is defined as

$${L}_{fas} = λ {L}_{as} + ( 1 - λ ) {L}_{f} ⇒ {L}_{fas} = \qquad ( 10 )$$

$$\frac{( 1 + {β}^{2} ) {\sum }_{i = 1}^{N} {p}_{i} {y}_{i}}{( 1 + {β}^{2} ) {\sum }_{i = 1}^{N} {p}_{i} {y}_{i} + {β}^{2} {\sum }_{i = 1}^{N} ( 1 - {p}_{i} ) {y}_{i} + {\sum }_{i = 1}^{N} {p}_{i} ( 1 - {y}_{i} )} - α ( 1 - λ ) {( 1 - p )}^{γ} log ( p )$$

where the choice of hyper-parameter λ=0.65 was made after several experiments.
c. Illustration of the Best Workable Embodiment of the System of the Invention

Tables 2-4 illustrate a detailed architectural implementation of the individual modules of the invention WDUNet of FIG. 3. The network architecture comprises nine convolution blocks, four max-pooling layers, four up-sampling convolution layers, and eight deformable convolution blocks. Initially, CT image patches of size 128×128 pixels are fed at the input. With a stride of 1, the patches filter through four sets of iterations encompassing 2×2 max-pooling layers, 3×3 convolution layers, and DC block layers. The 2×2 Up-sampling layers of the decoder aid in regaining the final resolution of the image(s).

| | | | | | | Weight Generation (WG) block | | | |
|---|---|---|---|---|---|---|---|---|---|
| | | | | (Kernel | # | | | Kernel | # |
| Block | Input | (size) | Layer | Size) | Kernels | Input | Layer | Size | Kernels |
| | Input: | (128*128*1) | | | | ConvX | WGZ | (3*3) | n |
| 1 | CT | (128*128*1) | DC1 | (3*3) | 16 | Deform- | | | |
| | image | | | | | BlockY | | | |
| | Deform- | (128*128*16) | conv1 | (3*3) | 16 | Deform- | conv^{a} | (1*1) | n |
| | Out1 | | | | | BlockY | | | |
| | conv1 | (128*128*16) | maxpooling1 | (2*2) | 16 | convX | conv^{b} | (1*1) | n |
| 2 | maxpooling1 | (64*64*16) | DC2 | (3*3) | 32 | conv^{a} | Add | | |
| | Deform- | (64*64*32) | conv2 | (3*3) | 32 | conv^{b} | | | |
| | Out2 | | | | | Add | ReLU | | |
| | conv2 | (64*64*32) | maxpooling2 | (2*2) | 32 | | activation | | |
| 3 | maxpooling2 | (32*32*32) | DC3 | (3*3) | 64 | ReLU | S | (1*1) | 1 |
| | Deform- | (32*32*64) | conv3 | (3*3) | 64 | activation | | | |
| | Out3 | | | | | S | Sigmoid | | |
| | conv3 | (32*32*64) | maxpooling3 | (2*2) | 64 | | Activation | | |
| 4 | maxpooling3 | (16*16*64) | DC4 | (3*3) | 128 | | (SA) | | |
| | Deform- | (16*16*128) | conv4 | (3*3) | 128 | convX | MultiplyZ | | |
| | Out4 | | | | | SA | | | |
| | conv4 | (16*16*128) | maxpooling4 | (2*2) | 128 | Deformable Convolution (DC) | | | |
| 5 | maxpooling4 | (8*8*128) | conv5 | (3*3) | 256 | LayerM | DCZ | (3*3) | n |
| | conv5 | (8*8*256) | conv6 | (3*3) | 256 | LayerM | conv^{d} | (3*3) | n |
| | conv6 | (8*8*256) | Upsampling1 | (2*2) | 256 | | Δ = 2D | | |
| | Upsampling1 | (16*16*256) | DC5 | (3*3) | 128 | | offsets | | |
| | conv4 | (16*16*128) | WG1 | | 128 | | (Δx, Δy), | | |
| | Deform- | (16*16*128) | | | | | ω = Learned | | |
| | Out5 | | | | | | Kernel | | |
| 6 | Upsampling1 | (16*16*256) | concat1 | | 384 | | weights, | | |
| | Multiply1 | (16*16*128) | | | | | Deform- | | |
| | concat1 | (16*16*384) | conv7 | (3*3) | 128 | | OutZ = | | |
| | conv7 | (16*16*128) | Upsampling2 | (2*2) | 128 | | ω* | | |
| | Upsampling2 | (32*32*128) | DC6 | (3*3) | 64 | | conv^{d} Δ | | |
| | conv3 | (32*32*64) | WG2 | | 64 | | | | |
| | Deform- | (32*32*64) | | | | | | | |
| | Out6 | | | | | | | | |
| 7 | Upsampling2 | (32*32*128) | concat2 | | 192 | | | | |
| | Multiply2 | (32*32*64) | | | | | | | |
| | concat2 | (32*32*192) | conv8 | (3*3) | 64 | | | | |
| | conv8 | (32*32*64) | Upsampling3 | (2*2) | 64 | | | | |
| | Upsampling3 | (64*64*64) | DC7 | (3*3) | 32 | | | | |
| | conv2 | (64*64*32) | WG3 | | 32 | | | | |
| | Deform- | (64*64*32) | | | | | | | |
| | Out7 | | | | | | | | |
| 8 | Upsampling3 | (64*64*64) | concat3 | | 96 | | | | |
| | Multiply3 | (64*64*32) | | | | | | | |
| | concat3 | (64*64*96) | conv9 | (3*3) | 32 | | | | |
| | conv9 | (64*64*32) | Upsampling4 | (2*2) | 32 | | | | |
| | | Upsampling4 | | (3*3) | 16 | | | | |
| (128*128*32) | | DC8 | | | | | | | |
| | conv1 | (128*128*16) | WG4 | | 16 | | | | |
| | Deform- | (128*128*16) | | | | | | | |
| | Out8 | | | | | | | | |
| 9 | Upsampling4 | (128*128*32) | concat4 | | 48 | | | | |
| | Multiply4 | (128*128*16) | | | | | | | |
| | concat4 | (128*128*48) | conv10 | (3*3) | 16 | | | | |
| | conv10 | (128*128*16) | conv11 | (1*1) | 1 | | | | |
| | conv11 | (128*128*1) | Sigmoid | | 1 | | | | |
| | | | activation | | | | | | |
| | Output: | (128*128*1) | | | | | | | |

The DC blocks are introduced in the first four encoder layers and the final four decoder layers. They assist in gathering ROI-specific data, thereby lowering any error at the segmentation boundary while increasing the accuracy. The position of the lung tumor infection lesions often overlap with the bone, bronchiole, and liver structures; besides, they resemble the bronchioles and are hence difficult to segment. Therefore, the high-level semantic feature maps in the decoder are concatenated through the W G module to focus on the lower-level details in the retrieved feature maps (of the encoder).

The up-sampled images are merged with their equivalent encoded representations to enhance the significance of a pixel through the W G module. Adaptive selection of spatial information is accomplished by highlighting the pixels from the ROI, while suppressing the less important ones. The last layer of the WDU-Net uses the sigmoid activation function to generate a probabilistic ROI at the output.

Data preparation: The pixel values were uniformly normalised in the range [−1024, 3071] HU to ensure fair comparison across data acquisition sources in CT. It also allows the model to observe and learn to distinguish between all other tissues encompassed in the CT scan, excluding the tumor. Thereby, the network can directly segment the tumor region from the whole image for subsequent analysis; instead of first removing the lung portion from the entire slice. Patches were extracted in such a way that the class imbalance between the cancerous and background regions could be minimized.

Training: There is an imbalance in the classes due to the scarcity of annotated training data depicting the infection masks. This was circumvented through the extraction of overlapping patches, which increased the training data size while uniformly representing the important ROI. The ground truth corresponding to each axial slice of each CT volume of the training data was checked for infected and non-infected regions. A slice was labeled as “non-infected” if it had no infected areas. Random patches of size 128×128 pixels were extracted. Each axial slice containing an infected region was designated as “infected”. Here twenty arbitrary bounding boxes of size 128×128 pixels were drawn over the ROI to extract the patches. All the twelve 128×128 pixels boundary patches (inside the 512×512 pixels axial slice) were then considered.

Testing: Patches were analogously extracted from the test image. However, unlike during training, here the overlap between the patches was kept at a minimum to avoid any possible missing patch edge regions. All non-overlapping patches were extracted, along with those overlapping patches having a 25% overlap from each of their corresponding four neighbouring patches. This is normally sufficient to cover the entire lung region in a CT sample. Axial slices (512×512 pixels) were taken from each test CT volume. Each slice produced sixteen 128×128 pixels of non-overlapping patches and nine 128×128 pixels overlapping patches.

Ensembling: The training set, constituting 263 patients, was randomly divided into ten bins, B1, B2, . . . , B10 followed by 10-fold cross validation. Training used ten versions of the WDU-Net, represented here as M1, M2, . . . , M10. While training one model, one of the ten bins was left for validation. The detail of data splitting for each of the ten versions of the training models (WDU-Net) is shown in Table 5. The corresponding validation datasets are the bins designated as B1, B2, . . . , B10, and elaborated in the table. As an illustration, in instance 1, the model M1 is trained using bins B2 through B10, and validated on the data in bin B1. Analogously, case 2 involves training M2 with bins B1 and B3 through B10, while validating upon bin B2. Here each model, from M1 to M10, is trained using a separate set of initialization, learning, dropout, and other parameters. The Adam optimizer was used, with a constant batch size of 16. After multiple studies, the learning rate and dropout probability were selected as 0.001 and 0.2, respectively. The present system is workable like any deep learning architecture based systems that needs tuning parameters like learning rate, dropout, batch size, which for the present system after several processor based computations, the provided values for the parameters are found to be selective.

Also the present technically advanced system including DU-Net and/or WDU-Net is governable by any qualifying trained datasets or any conventional convolution network based image dataset that can be readily involved to generate the image accuracy and segmentation when run under DU-Net and/or WDU-Net framework architecture of the present system so long as the pixel value of medical image is preserved in file formats including file formats of .dicom or .nii, with .jpg or .png being non-supportive file formats.

TABLE 5
Ensembled WDU-Net model Mi, with the performance evaluated on the
corresponding validation set Bi

| | | | | Performance evaluation metric | | | | |
|---|---|---|---|---|---|---|---|---|
| Model | Training | Validation | DSC | JSC | Precision | AUC | Recall | HD95 |
| M1 | B/{B1} | B1 | 0.8707 | 0.6934 | 0.8032 | 0.8905 | 0.8213 | 14.0562 |
| M2 | B/{B2} | B2 | 0.8318 | 0.7129 | 0.7841 | 0.8219 | 0.8567 | 9.5277 |
| M3 | B/{B3} | B3 | 0.9047 | 0.7735 | 0.8537 | 0.8927 | 0.8629 | 9.3801 |
| M4 | B/{B4} | B4 | 0.8920 | 0.7310 | 0.8217 | 0.8834 | 0.8874 | 12.3549 |
| M5 | B/{B5} | B5 | 0.8516 | 0.6813 | 0.8109 | 0.8269 | 0.8130 | 8.2713 |
| M6 | B/{B6} | B6 | 0.8817 | 0.6720 | 0.8573 | 0.9017 | 0.8505 | 10.6405 |
| M7 | B/{B7} | B7 | 0.8681 | 0.7703 | 0.8148 | 0.8852 | 0.8280 | 7.2780 |
| M8 | B/{B8} | B8 | 0.8591 | 0.7418 | 0.8336 | 0.8470 | 0.8517 | 8.3924 |
| M9 | B/{B9} | B9 | 0.8959 | 0.8014 | 0.8539 | 0.8802 | 0.8833 | 12.1390 |
| M10 | B/{B10} | B10 | 0.9065 | 0.7972 | 0.8725 | 0.8934 | 0.8848 | 11.3424 |
| | | Mean ⇒ | 0.8762 | 0.7375 | 0.8306 | 0.8723 | 0.8540 | 10.3383 |
| | | std. dev. ⇒ | 0.0232 | 0.0448 | 0.0268 | 0.0277 | 0.0254 | 2.0305 |

where B = { Bi: i ϵ N ∧ i ϵ [1, 10] }

The WDU-Net was trained on the CT images of 263 patients, through ensembling of ten base-classifiers using ten sets of data. Each classifier starts from scratch and uses only nine bins (Table 5) of the data during training. Therefore, each time it creates an entirely new classifier with a unique set of parameters. Each scenario leaves one bin for validation. The five independently-collected, publicly available test datasets (Table 1) were then used for testing the ten trained WDU-Net models, whose outputs were ensembled to segment the lung tumor infection region via majority voting. The performance, evaluated in terms of the different metrics, was observed to be consistent, accurate and reliable across the ten models; depicting good generalisation with 10-fold training. The models were implemented in the Tensorflow framework with a dedicated GPU (NVIDIA TESLA V100 having capacity of 16 GB), running behind the wrapper library Keras with Python 3.6.8, Keras 2.2.4, and Tensorflow-GPU version 1.13.1.

Highlights of the uniqueness and non-obviousness of the invention, where a unique novel deep Weighted Deformable segmentation network (WDU-Net) could be invented for the efficient segmentation of tumors from lung CT, involving ensembled inferencing.

Comparative study: The model performed better, as compared to state-of-the-art models, in many aspects. The reason was three-fold. (1) The DC module captured the unknown geometric shape of the tumor region, assisted by the W G module for suppressing unimportant features and highlighting the relevant ones. (2) The F AS loss function, a judicious combination of the Focal loss and Asymmetric Similarity loss, helped to effectively model class imbalance. (3) The patch-based training aided improved and balanced learning. Combining the outputs of ten ensembled classifiers, through majority voting, added another dimension to the inference process while arriving at a proper decision regarding the segmentation of the ROI. The performance of some of the effective state-of-the-art methods, as reported in related literature on lung tumor segmentation, are compared in Table 6 with reference to that of the invented WDU-Net. The performance metrics used were DSC, JSC, and Precision. In each case the test datasets were as indicated in the first column of the table.

TABLE 6
Comparative analysis of recent literature
on deep learning in segmentation of lung CT

| Dataset | | | | |
|---|---|---|---|---|
| Performance Metric | Methodology | DSC | JSC | Precision |
| NSCLC [17] | Transfer Learning | 0.7255 | | |
| Radiogenomics [24] | WDU-Net | 0.8534 | 0.7213 | 0.8125 |
| LIDC-IDRI [26] | Unet++ [14] | | 0.7705 | |
| residual network [19] | Residual Unet [15] | 0.8755 | | |
| squeeze-and-excitation | CoLe-CNN [16] | 0.8610 | 0.7660 | |
| U-Net [20] | Dual branch | 0.8274 | | |
| | Multi-scale | 0.8050 | 0.6800 | |
| | WDU-Net | 0.9137 | 0.8503 | 0.8817 |
| Model [21] | Teacher-student | 0.7100 | | |
| Decathlon [25] | Residual separable | 0.6490 | | 0.7650 |
| CNN [18] | WDU-Net | 0.8201 | 0.7124 | 0.7940 |
| Similarity Index (3D): 0.7829 | Ensemble segmentation [8] | | | |
| Moffitt [27] | WDU-Net | 0.7965 | 0.7173 | 0.8021 |
| Aggregation [7] | Multi-view | | 0.7004 | |
| Rider [28] | WDU-Net | 0.8924 | 0.8113 | 0.7629 |
| Model [21] | Teacher-student | 0.5389 | | |
| NSCLC | Recurrent 3D- | 0.7228 | | |
| Dense U-Net [31] | Dilated hybrid-3D | 0.6577 | | |
| Radiomics [23] | Multi-scale | 0.7800 | 0.6440 | |
| CNN [32] | WDU-Net | 0.8707 | 0.6934 | 0.8306 |
| squeeze-and-excitation | | | | |
| U-Net [20] | | | | |

The invented WDU-Net was fast in learning, with limited data, and produced good generalization. It was observed through ablation studies that the DC and W G modules could help the network focus on the ROI. The training and testing times were also lower. Ensembled inferencing provided an effective strategy for combined decision-making. The high accuracy and robustness of the output was due to the reduction in over-and-under segmentation.

Impact of DC module: The fixed geometric structure of conventional convolution modules often constrains their capability in modeling large-scale unknown geometric transformations. The input feature map gets sampled at predetermined locations, with all the activation units of a layer having the same receptive field size. This becomes problematic at the higher levels of the CNN when encoding the semantics across spatial locations. Adaptive determination of the scales or receptive field sizes often becomes desirable for visual recognition involving fine localisation. This is because different locations may correspond to objects possessing varying scales or deformation. The deformable convolution (DC) augmented the ordinary grid sampling points in the standard convolution by adding 2D offsets, as depicted in FIG. 2a. This enabled the sampling grid to be deformed freely, with the offset learning module including a few extra parameters and computations. Here the receptive field of the operator can be adapted to the target region of interest (ROI) by deforming (or warping) the kernel throughout.

The effect of the DC on the feature maps generated by our WDU-Net, at different stages of training, were also analysed. It is evident from FIG. 4 that the weighted DC helps the network converge faster on the ROI. Here the feature map is displayed after the 5th, 10th, 15th, 20th, 25th and 30th epochs, respectively. The ROI is observed to be gradually estimating the target ground truth, as depicted in the figure. It is also seen that the convergence to the ROI is faster and more accurate, as compared to the model when not incorporating DC module.

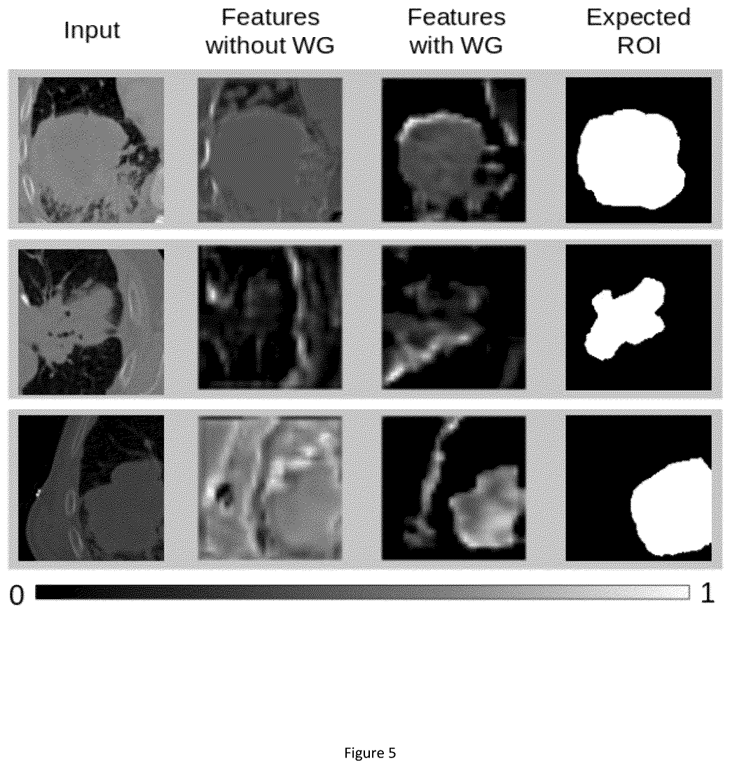

Impact of WG module: Incorporating weight generation (WG) module into the network architecture of FIG. 3 (blue circle) achieves dynamic assignment of importance to different spatial locations in the feature maps. This allows more precise and accurate information fusion between the encoder and decoder pathways. Thereby, the network is able to capture finer details for improving the segmentation performance; particularly, in those regions of the input image that require higher focus and refinement. The claim can be validated from FIG. 5, where sample intermediate feature maps generated with and without incorporating the WG modules are provided. It is evident that the feature maps generated with WG provide a better match with the expected ROI depicted in the last column of FIG. 5.

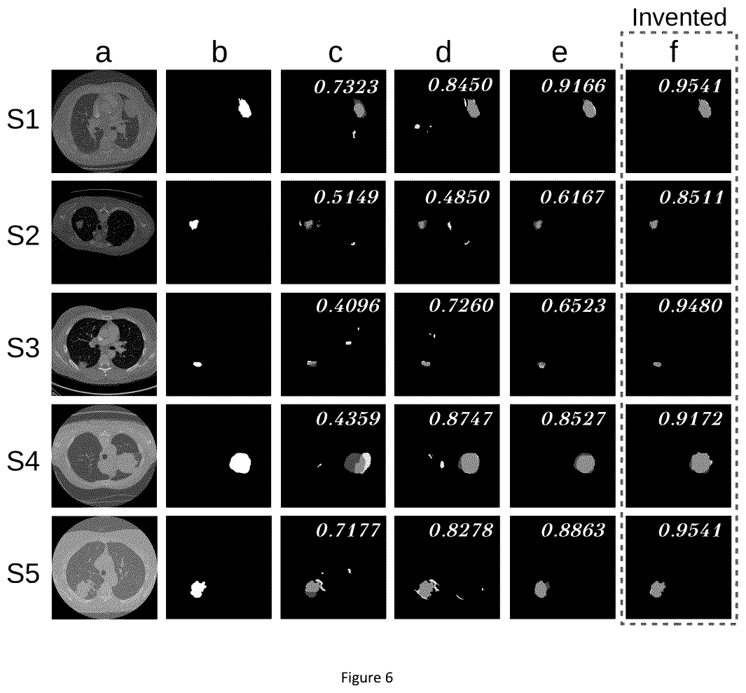

Ablations: The goal is to segment a CT lung image into the ROI (i.e, lung tumor) from the background (containing all other regions in the image). This is often difficult for a conventional U-Net. The deformable convolution DC circumvents the problem by appropriately incorporating the necessary local and neighborhood information for precise delineation of the ROI, while the W G module helps to focus attention on it. The loss function F AS [eqn. (10)] handles class imbalance within image patches. We explored the effect of the different modules, additively included in the WDU-Net model. These include the vanilla U-Net, Attention U-Net, DU-Net (with DC but without W G), and the invented WDU-Net. In all the tables here, the best output scores are marked in bold; with all scores being appended by the corresponding standard deviation (s.d.) A comparative visual study on one slice, from each test dataset, is presented in FIG. 6. The sample slices from the five test datasets are selected as S1 from NSCLC Radiogenomics, S2 from Decathlon, S3 from LIDC-IDRI, S4 from Moffitt, and S5 from Rider. It is observed that the red (under-segmented) and yellow (over-segmented) portions are minimum in our WDU-Net, whereas the mismatch of the vanilla U-Net in column (c) is maximum as compared to the ground truth. The results are depicted for different sizes of ROIs, encompassing the very small as well as the larger ones; In all cases the invented WDU-Net performed the best.

The model complexity, in terms of the number of parameters, is enumerated in Table 7. Note that the overall comparative performance of the ensembled WDU-Net is better than its other variants, as evident from the table.

TABLE 7
Computational complexity of the various modules of WDU-Net

| | | Attention | DU - | WDU - |
|---|---|---|---|---|
| Model | ⇒ U -Net | U -Net | Net | Net |
| # parameters | ⇒ 1.96M | 1.99M | 3.92M | 3.95M |
| # epochs Training | ⇒ 80 | 80 | 40 | 40 |
| Training time, with | ⇒ 72 | 79 | 56.5 | 64 |

Difference between DC versions: The DC for semantic segmentation was modified. Earlier the DC was used for object detection. In the present case, it is seen from FIG. 2a that the DC tries to capture the full Region of Interest (ROI) (ROI is Ground Truth as specified in the figure) through the learning of the offset A (see bottom right of the figure). Here Δx is the offset to move along the x-direction, and Δy is the offset to proceed in the y-direction to grab the whole ROI, instead of capturing only a part of the ROI as in basic convolution. The main difference between existing basic DC and the present DC is as follows. The basic DC tries to extract the maximum number of pixels located within the ROI, and assists in handling objects at diverse scales and shapes. The present modification on the DC strives to focus on the exact geometrical shape of the ROI, contour it out, and helps capture the fine-grained details for improving the accuracy of ROI localization within the image. The mathematical details are evident from Eqn. (2).

Physical parameters: For the experiments the full CT image sizes were 512×512, while the CT patch sizes were 128×128. The CT intensity was specified in Hounsfield Units, it was normalized within the range [−1024, 3071]; followed by normalization between [0,1](intermediate values are kept as float values). The color, as seen from the image, is gray-valued. Whenever the feature maps are shown, to depict the gray-scale image were tried with a color map specified in the legend of FIG. 2b; where 0 indicates the black region, and while moving towards 1 (white) the color changes black->violet->yellow. The block level view of FIG. 2b, which additionally indicates the stages of refinement in terms of the color map (as explained above). The corresponding features, extracted at the output of the respective blocks, are also illustrated. The number of pixels are indicated above each such extracted feature image. The pixel values lie in [0, 1].

Quantitative assessment: Results of Table 8 and FIG. 3d provide a measure of the quantitative assessment of the effectiveness of each module with/without others, as evaluated on the five publicly available datasets. Other combinations were deemed superfluous to explore. The performance metrics used were DSC, JSC, Precision, AUC, Recall and HD95. Here U-Net is the model where DCs were replaced with basic convolution, and there is no WG. W U-Net is the model where DCs were replaced with basic convolution, and there is WG. DU-Net is the model where DCs were kept as it is, and there is no WG. W DU-Net is our model of FIG. 2b. Additionally, the bar charts (with line charts, depicting the error with standard deviation) help visualize the comparative study (of the table) in FIG. 3d. The effect of loss function FAS is demonstrated in Table 9.

Technical significance: Module WG allow the model to selectively increase the weight on relevant image regions, while suppressing the weights of irrelevant or noisy regions through the weightage matrix of eqn. (3) and its normalized version in eqn. (4). This weightage matrix improves the accuracy and precision of image segmentation, as the model can now attach more importance to areas containing relevant features. The WG module also helps to improve the localization of segmented objects, by highlighting their boundaries more effectively. Image segmentation often involves distinguishing objects that are visually similar or share common features. WG enables the model to emphasize the contextual information which aids in distinguishing between such objects. It reduces the potential confusion between similar patterns, by attending to the relevant context. By computing the weighted feature map, which is a product of the normalized weightage matrix and feature from the respective level of encoder arm [See eqn. (5)], it also enhances the model's ability to handle variations in image quality or artifacts that may arise during processing at the deeper levels. Maxpooling is performed here with a 2×2 kernel, that reduces the spatial dimensions of an image while retaining the most prominent features. It divides the input image into non-overlapping 2×2 regions and selects the maximum pixel value within each region. The result is a down-sampled image with reduced size, preserving the most salient information and creating spatial invariance. Up-sampling is performed by 2×2 kernel in the context of image processing. This increases the spatial dimensions of an image by duplicating pixels. It takes each pixel in the input image and replicates it to a 2×2 block in the output image, resulting in an output that is twice the size in both width and height. This process helps restore the spatial details, and any resolution lost during Maxpooling; thereby, allowing for a higher level of detail in the resulting image.

The Basic Convolution of eqn. (1), applied to an image, involves sliding a small filter (also known as a kernel) over the image and performing a mathematical operation at each position. At each position, the filter is multiplied element-wise with the corresponding image pixels within its receptive field, and the resulting values are summed up to produce a single output pixel. This process is repeated for every position in the image; thereby, resulting in a transformed image showing some important features. The DC designed by us has been elaborated above in terms of eqn. (2). The role of each block is experimentally demonstrated, in terms of the performance metrics, in Table 8 below.

TABLE 8
Comparative performance on unseen test data, using ensembling with F AS loss

| | Test Data | | | | |
|---|---|---|---|---|---|
| | Metrics | U-Net | WU-Net | DU-Net | WDU-Net |
| Radiogenomics | DSC ↑ | 0.5909 ± 0.175 | 0.6871 ± 0.132 | 0.8228 ± 0.147 | 0.8534 ± 0.112 |
| | JSC ↑ | 0.4783 ± 0.192 | 0.5205 ± 0.140 | 0.6715 ± 0.152 | 0.7213 ± 0.117 |
| | NSCLC | 0.6228 ± 0.136 | 0.7234 ± 0.132 | 0.7855 ± 0.149 | 0.8125 ± 0.124 |
| | Precision ↑ | | | | |
| | AUC | 0.6514 ± 0.155 | 0.7301 ± 0.149 | 0.8037 ± 0.179 | 0.8724 ± 0.107 |
| | Recall ↑ | 0.6687 ± 0.134 | 0.6325 ± 0.127 | 0.7990 ± 0.151 | 0.7807 ± 0.115 |
| | HD95 ↑ | 42.7433 ± 15.071 | 46.7623 ± 13.596 | 13.3417 ± 10.005 | 4.4721 ± 2.571 |
| Decathlon | DSC ↑ | 0.4802 ± 0.182 | 0.6277 ± 0.159 | 0.7274 ± 0.130 | 0.8201 ± 0.123 |
| | JSC ↑ | 0.3997 ± 0.173 | 0.5721 ± 0.164 | 0.6430 ± 0.127 | 0.7124 ± 0.134 |
| | Precision ↑ | 0.5203 ± 0.150 | 0.6039 ± 0.147 | 0.6617 ± 0.131 | 0.7940 ± 0.127 |
| | AUC ↑ | 0.4721 ± 0.143 | 0.6448 ± 0.129 | 0.7093 ± 0.122 | 0.8531 ± 0.114 |
| | Recall ↑ | 0.4925 ± 0.165 | 0.6001 ± 0.142 | 0.7304 ± 0.124 | 0.7712 ± 0.102 |
| | HD95 ↑ | 56.3592 ± 18.037 | 34.0561 ± 17.998 | 19.0104 ± 12.351 | 9.0219 ± 3.782 |
| LIDC-IDRI | DSC ↑ | 0.5841 ± 0.138 | 0.7022 ± 0.156 | 0.8553 ± 0.120 | 0.9137 ± 0.075 |
| | JSC ↑ | 0.5067 ± 0.151 | 0.5993 ± 0.142 | 0.7380 ± 0.139 | 0.8503 ± 0.106 |
| | Precision ↑ | 0.5432 ± 0.145 | 0.6347 ± 0.137 | 0.6851 ± 0.105 | 0.8817 ± 0.119 |
| | AUC ↑ | 0.6018 ± 0.157 | 0.7089 ± 0.150 | 0.8427 ± 0.134 | 0.9449 ± 0.101 |
| | Recall ↑ | 0.5727 ± 0.133 | 0.6943 ± 0.137 | 0.7528 ± 0.127 | 0.8586 ± 0.115 |
| | HD95 ↑ | 38.2178 ± 14.819 | 29.7513 ± 15.176 | 14.3386 ± 12.389 | 5.3852 ± 1.051 |
| Moffitt | DSC ↑ | 0.4698 ± 0.187 | 0.6550 ± 0.162 | 0.7121 ± 0.134 | 0.7965 ± 0.114 |
| | JSC ↑ | 0.3821 ± 0.163 | 0.5773 ± 0.140 | 0.6729 ± 0.127 | 0.7173 ± 0.120 |
| | Precision↑ | 0.4805 ± 0.182 | 0.6271 ± 0.201 | 0.6935 ± 0.183 | 0.8021 ± 0.123 |
| | AUC ↑ | 0.5043 ± 0.252 | 0.6720 ± 0.145 | 0.7532 ± 0.130 | 0.7924 ± 0.110 |
| | Recall ↑ | 0.4927 ± 0.194 | 0.6754 ± 0.176 | 0.6937 ± 0.119 | 0.7447 ± 0.124 |
| | HD95 ↑ | 45.2012 ± 19.099 | 43.3990 ± 13.285 | 16.5634 ± 15.462 | 11.6568 ± 3.037 |
| Rider | DSC ↑ | 0.6200 ± 0.237 | 0.7463 ± 0.138 | 0.8447 ± 0.114 | 0.8924 ± 0.096 |
| | JSC ↑ | 0.5601 ± 0.187 | 0.7039 ± 0.170 | 0.7744 ± 0.116 | 0.8113 ± 0.124 |
| | Precision ↑ | 0.6437 ± 0.159 | 0.7006 ± 0.201 | 0.7302 ± 0.127 | 0.7629 ± 0.138 |
| | AUC ↑ | 0.6672 ± 0.166 | 0.7547 ± 0.152 | 0.8816 ± 0.137 | 0.9120 ± 0.110 |
| | Recall ↑ | 0.6723 ± 0.139 | 0.7003 ± 0.122 | 0.7357 ± 0.139 | 0.7735 ± 0.129 |
| | HD95 ↑ | 27.0592 ± 14.995 | 21.4244 ± 19.098 | 11.7993 ± 8.5051 | 5.0320 ± 3.937 |

↑: Greater value indicates better prediction
↑: Smaller value indicates better prediction.

Effect of modules: Seen under Tables 8-9, and FIG. 3d

TABLE 9
Effect of loss functions on DSC for the WDU-
Net, with ensembling, over the test datasets

| | NSCLC | | LIDC- | | |
|---|---|---|---|---|---|
| Loss | Radiogenomics | Decathlon | IDRI | Moffitt | Rider |
| FL | 0.8198 ± | 0.7027 ± | 0.7597 ± | 0.7129 ± | 0.8297 ± |
| | 0.143 | 0.156 | 0.154 | 0.139 | 0.110 |
| ASL | 0.7635 ± | 0.6916 ± | 0.7735 ± | 0.6807 ± | 0.8039 ± |
| | 0.129 | 0.134 | 0.127 | 0.131 | 0.118 |
| FAS | 0.8534 ± | 0.8201 ± | 0.9137 ± | 0.7965 ± | 0.8924 ± |
| | 0.112 | 0.123 | 0.074 | 0.114 | 0.096 |

Block-level architecture with extracted features flows from FIG. 2b.

1. A Convolutional Neural network (CNNs) based system for image analysis including for computer aided detection/diagnosis comprising:
an imaging means including a scanner means for generating image features from variety of images of subjects for required image analysis;
convolution network module including U-net image segmentation processing means and variants thereof comprising U-net framework for down- and up-sampling of the image under analysis involving encoder and decoder arms for desired semantic image segmentation;
said convolution network module adapted for semantic segmentation of the image for screening and detection/diagnosis of diseased (infected) volumes/regions from images including even complex and unknown boundaries includes deformable convolution (DC) modules, down sampling based max pooling layers, up-sampling convolution layers and basic convolution modules,
said deformable convolution (DC) module including a processor for a learnable and dynamic receptive field based deformation in free form of a sampling grid involving a 2D offset generator to said sampling grid points thereby adapted to generate transformed images with precise detection and segmentation covering full regions of interest (ROI) including adaptive to the scale and shape of said ROI and based on an input image feature generating an output image feature ‘F’, corresponding to pixel location (i, j) at output channel (m) of the encoder/decoder arms of the module as per Eq. 2 below,
$${ℱ}_{i , j}^{m} = {\sum }_{c = 1}^{C} {\sum }_{p = - ⌊ K / 2 ⌋}^{⌊ K / 2 ⌋} {\sum }_{q = - ⌊ K / 2 ⌋}^{⌊ K / 2 ⌋} {ω}_{p , q}^{m} {X}_{\{ ( i + p ) + {Δ}_{x}^{( i + p )} \} , \{ ( j + q ) + {Δ}_{y}^{( j + q )} \}}^{c} . \qquad ( 2 )$$
wherein Δₓ and Δ_{y} in the generated output image feature cover capture of full Region of Interests (ROI) with said Δ_{X} being offset in x-direction and Δ_{y} being offset in y-direction enabling precise detection and segmentation covering full regions of interest (ROI) even with arbitrary shapes and sizes of diseased (infected) volumes/regions of images.

2. The Convolutional Neural network (CNNs) based system as claimed in claim 1, wherein said processor for a learnable and dynamic receptive field based deformation in free form of a sampling grid involving a 2D offset generator to generate transformed image with precise detection and segmentation covering full regions of interest (ROI) includes said Δₓ and Δ_{y} as learned offset input based pixel location shifter to enable shift in pixel position along the abscissa and ordinate respectively with said output feature ‘F’ based image map generator corresponding to said pixel location (i, j) of input image feature, generated by basic convolution module and including said Δₓ and Δ_{y} such as Δ={(Δⁿₓ, Δⁿ_{y}) 1≤n≤K²} as said set of paired learnable offsets of size H×W on basic convolution operator to thus include in said output feature selectively shifted pixel location along abscissa and ordinate based on a dynamic offset value in turn enabling capture of receptive field adapted to the features of the input thus facilitating precise ROI segmentation,
with said basic convolution operator being represented by Equation 1 below:
$${ℱ}_{i , j}^{m} = {\sum }_{c = 1}^{C} {\sum }_{p = - ⌊ K / 2 ⌋}^{⌊ K / 2 ⌋} {\sum }_{q = - ⌊ K / 2 ⌋}^{⌊ K / 2 ⌋} {ω}_{p , q}^{m} {X}_{\{ i + p \} , \{ j + q \}}^{c} . \qquad ( 1 )$$
where ‘c’={1, . . . , C} refers to the input channels, ‘m’={1, . . . , M} corresponding to the output channels, and K is assumed to be odd, when an input feature map X of size H×W×C is considered, where H represents the height, W corresponds to the width, and C refers to the number of input channels in basic convolution module operational based on said basic convolution operator operable preferably on a kernel size (K×K) producing an output feature map ‘F’ of size H×W×M with ‘M’ indicating the number of output channels considering, ω={ωⁱ|1≤i≤M; ωⁱ ∈(K×K)} is a set of learnable kernel weights of size K×K×M.

3. The Convolutional Neural network (CNNs) based system for image analysis as claimed in claim 1, wherein said convolution network module in its framework comprises WDU-Net (Deep Weighted Deformable Segmentation Network) comprising group of Weight generation (WG) modules/processor blocks with said Deformable Convolution (DC) modules/processor blocks for down- and up-sampling of image under analysis along said encoder and decoder arms of U-Net framework for generating weighted combination based feature maps on deformable convoluted (DC) transformed images with localization of segmented objects and/or generating highlighted boundaries thereof and related image segmentation for distinguishing objects in image which are visually similar or share common features involving dynamic assignment of importance to relevant spatial locations of the corresponding image feature including suppressing unimportant features and highlighting relevant features within said full regions of interest (ROI) generated by said deformable convolution (DC) module for advanced image segmentation.

4. The Convolutional Neural network (CNNs) based system for image analysis as claimed in claim 3, wherein said WG means/modules provide for computed weighted matrix based weighted feature map generation including:
(i) computing means for basic convolution operator based on image inputs following Eq. 1
$${ℱ}_{i , j}^{m} = {\sum }_{c = 1}^{C} {\sum }_{p = - ⌊ K / 2 ⌋}^{⌊ K / 2 ⌋} {\sum }_{q = - ⌊ K / 2 ⌋}^{⌊ K / 2 ⌋} {ω}_{p , q}^{m} {X}_{\{ i + p \} , \{ j + q \}}^{c} . \qquad ( 1 )$$
where ‘c’={1, . . . , C} refers to the input channels, ‘m’={1, . . . , M} corresponding to the output channels, and K is assumed to be odd, when an input feature map X of size H×W×C is considered, where H represents the height, W corresponds to the width, and C refers to the number of input channels in basic convolution module operational based on said basic convolution operator operable preferably on a kernel size (K×K) producing an output feature map ‘F’ of size H×W×M with ‘M’ indicating the number of output channels considering, ω={ωⁱ|1≤i≤M; ωⁱ ∈(K×K)} is a set of learnable kernel weights of size K×K×M;
(ii) adder means for introducing said convolution operator to combine said feature maps along the encoder arm pathway with the corresponding ones at the decoder arm pathway of said U-Net following the encoder pathway to be E={Eᵢ|1≤i≤L}, where L is number of levels in the network and Eᵢ corresponds to the feature map from the encoder pathway at level I, which analogously for the decoder pathway is D={Dᵢ|1≤i≤L}, where Di is the feature map from the decoder pathway at the same level I, where (Eᵢ, Dᵢ)∈H×W×C;
(iii) weightage matrix computing means involving Sᵢ being computed as per Eq. (3) below by employing basic convolution operator of said Eqn. (1) above on both said Eᵢ and Dᵢ to reduce their channel dimensions having convᵢ^{a}=C_{1×1}(Dᵢ) and convᵢ^{b}=C_{1×1} (Eᵢ), where C_{1×1} denotes the 1×1 convolution,
$${S}_{i} = {𝒞}_{1 \times 1 \times 1} \{ ReLU ( {conv}_{i}^{a} ⊕ {conv}_{i}^{b} ) \} . \qquad ( 3 )$$
and, normalized weightage matrix computing means wᵢ as given by Eq. 4 below involving sigmoid operation (σ) applied along spatial dimensions:
$${w}_{i} = σ ( {S}_{i} ) \text{?} \qquad ( 4 )$$
$$\text{?} \text{indicates text missing or illegible when filed}$$
and finally (iv) weighted feature map generator Gᵢ including computing means by element-wise multiplication ⊗ of the normalized weight matrix with the feature map Eᵢ from the encoder arm as per Eq. 5 hereunder:
$$𝒢 = {w}_{i} ⊗ {E}_{i} . \qquad ( 5 )$$
said weight generation computing means providing for assigning each pixel with necessary weight by suppressing unimportant features at encoding and decoding arm of the deformable convolution (DC) and generating weighted combination based feature maps on deformable convoluted (DC) transformed images with localization of segmented objects and/or generating highlighted boundaries thereof and related image segmentation for distinguishing objects in image which are visually similar or share common features involving dynamic assignment of importance to relevant spatial locations of the corresponding image feature including suppressing unimportant features and highlighting relevant features within said full regions of interest (ROI) generated by said deformable convolution (DC) module for advanced image segmentation.

5. The Convolutional Neural network (CNNs) based system for image analysis as claimed in claim 3, wherein said U-net framework for down- and up-sampling of the image under analysis involving encoder and decoder arms include said weight generation (WG) and Deformable Convolution (DC) blocks processor, with said WG mechanism assigning each pixel the necessary weight during decoding of the DC enabling faster network convergence on the desired ROI and said offset and output feature generating convolution kernel means including trained feature operative sets.

6. The Convolutional Neural network (CNNs) based system for image analysis as claimed in claim 3, wherein said U-net framework include image patch filter means included iteration enabling disposition of max-pooling layers, convolution layers, DC block layers and up-sampling layer of the decoder generating regained final resolution of the image patch with high level semantic feature based image patch/map in the decoder concatenated through WG module for focused lower level details of feature maps of the encoder,
said WG module enabling merging of the up-sampled images with equivalent encoded representations to thereby enhance significance of a pixel and highlighting of pixels from ROI for generating relevant adaptive selection based spatial information.

7. The Convolutional Neural network (CNNs) based system for image analysis as claimed in claim 4, wherein said weight generation (WG) module as weight segmentation mask has its gradient at each level of decoder arm in the network that includes computing means based on analytical parameter ‘θ’ for back propagating the error using the chain rule as set forth under Eq. 6 below:
$$\frac{\partial {W}_{i}}{\partial θ} = \frac{\partial {ϕ}_{wgt}}{\partial {W}_{i}} \frac{\partial {f}_{dec}}{\partial {Z}_{i}} \frac{\partial {Z}_{i}}{\partial θ} + \frac{\partial {ϕ}_{wgt}}{\partial {W}_{i}} \text{?} \qquad ( 6 )$$
$$\text{?} \text{indicates text missing or illegible when filed}$$
considering the weight mask at ith level is Wᵢ, with analytic parameter θ, where ∂ϕ_{wgt}/∂Wᵢ is the gradient of the weight generation operation w.r.t. the weighted mask, ∂f_{dec}/∂Zᵢ is the gradient of the decoder arm w.r.t. the DC block, and ∂Zᵢ/∂θ is the gradient of the DC block w.r.t. the analytic parameters, and wherein gradient of DC block in respect of analytic parameter, at each level (i) of the encoder arm translates to:
$$\frac{\partial {Z}_{i}}{\partial θ} = \frac{\partial {ϕ}_{conv}}{\partial {Z}_{i}} \frac{\partial {Z}_{i - 1}}{\partial θ} + \frac{\partial {ϕ}_{conv}}{\partial θ} \text{?} \qquad ( 7 )$$
$$\text{?} \text{indicates text missing or illegible when filed}$$
where ∂ϕ_{conv}/∂Zᵢ is the gradient of the basic convolution w.r.t. DC, and ∂ϕ_{conv}/∂θ is the gradient of convolution w.r.t. analytic parameter considering Z₀ represents input to the network, which is CT image patch.

8. The Convolutional Neural network (CNNs) based system for image analysis as claimed in claim 4, wherein said convolution network module framework based image segmentation means include focal asymmetric loss (FAS) based functional operator means for improved segmentation of image data with class imbalance when said ROI is small in size with respect to image background and where positive number of pixels are relatively insufficient including:
consecutive focal loss (FL) based operator means represented by Eq. 8 below:
$$ℒ \text{?} ( {p}_{i} ) = - {α ( 1 - {p}_{i} )}^{γ} log ( {p}_{i} ) . \qquad ( 8 )$$
$$\text{?} \text{indicates text missing or illegible when filed}$$
considering ground truth segmentation mask (for N pixels) to be y∈{±1}, with the corresponding predicted mask being ŷ having estimated probability p∈[0,1] with experimentally selected weighting factor α=0.7 and focusing parameter γ=2;
followed by asymmetric similarity loss (ASL) operator means that adjusts the weights between false positive (F P) and false negative (F N) (thereby, achieving a good balance between precision and recall) while training a network over highly imbalanced data, said asymmetric similarity loss operation defined as below:
$${ℒ}_{as} ( y , p ) = \frac{( 1 + {β}^{2} ) {\sum }_{i = 1}^{N} {p}_{i} {y}_{i}}{( 1 + {β}^{2} ) {\sum }_{i = 1}^{N} {p}_{i} {y}_{i} + {β}^{2} {\sum }_{i = 1}^{N} ( 1 - {p}_{i} ) {y}_{i} + {\sum }_{i = 1}^{N} {p}_{i} ( 1 - {y}_{i} )} . \qquad ( 9 )$$
and applying adder means for combination of merits of loss functions of Eqns. (8)-(9) as the new Focal asymmetric loss (FAS) for improved segmentation of highly imbalanced data, with the ROI being very small in size with respect to the background region definable as:
$${ℒ}_{fas} = {λℒ}_{as} + ( 1 - λ ) {ℒ}_{f} \text{?} ⇒ {ℒ}_{fas} = \frac{( 1 + {β}^{2} ) {\sum }_{i = 1}^{N} {p}_{i} {y}_{i}}{\begin{matrix}( 1 + {β}^{2} ) {\sum }_{i = 1}^{N} {p}_{i} {y}_{i} + {β}^{2} {\sum }_{i = 1}^{N} ( 1 - {p}_{i} ) {y}_{i} + \\ {\sum }_{i = 1}^{N} {p}_{i} ( 1 - {y}_{i} ) - α ( 1 - λ ) {( 1 - {p}_{i} )}^{γ} log ( {p}_{i} )\end{matrix}} \text{?} \qquad ( 10 )$$
$$\text{?} \text{indicates text missing or illegible when filed}$$
considering hyper-parameter λ=0.65.

9. The Convolutional Neural network (CNNs) based system for image analysis as claimed in claim 1, wherein said 2D offset generator include pair of learnable offsets for DC which are derived by applying convolutional layer over the same input feature map with the spatial resolution and dilation of the convolution kernel being identical to those of the current convolutional layer with the spatial resolution of the output offset field matching with that of the corresponding input feature map, with the channel dimension 2N equivalent to N×2D offsets, with both the offsets and output feature-generating convolution kernels being concurrently obtained during automated analysis.

10. The Convolutional Neural network (CNNs) based system for image analysis as claimed in claim 1, wherein the convolution network module comprises nine numbers of convolution processor blocks, four max-pooling layers, four up-sampling convolution layers, and eight deformable convolution (DC) blocks to operate on input CT image patch of size 128×128 pixels fed at the input, with stride of 1 filtering the patches through four sets of iterations at encoder arm of DC encompassing 2×2 down-sampling based max-pooling layers, 3×3 basic convolution layers, and deformable convolution (DC) block layers, with 2×2 up-sampling layers at the decoder arm aiding in regaining final resolution of the image(s).

11. The Convolutional Neural network (CNNs) based system for image analysis as claimed in claim 3, wherein in said convolution module said DC processor blocks are included in the first four down-sampling based max-pooling encoder layers and the final four up-sampling decoder layers for gathering ROI-specific data, to lower overlap based error at the segmentation boundary while increasing the accuracy of segmentation and to enable storage of high-level semantic feature based image maps in the decoder;
said WG module processor blocks interactive with DC blocks concatenates said high-level semantic feature based image maps stored in the up-sampled decoder arm of DC blocks to focus on the lower-level details in the retrieved encoder feature maps of DC blocks for merging of said up-sampled images with their equivalent encoded representations thereby enhancing significance/weightage of a pixel through said WG module allowing adaptive selection of pixel spatial information by highlighting pixels from the ROI, while suppressing the less important ones, with said last layer of WDU-Net (Deep Weighted Deformable Segmentation Network) involving sigmoid activation function based processer to generate a probabilistic ROI at the system output, as per the block based system architecture below:

| Block | Input | (size) | Layer | (Kernel Size) | #Kernels |
|---|---|---|---|---|---|
| | Input | (128*128*1) | | | |
| 1 | CT image | (128*128*1) | DC₁ | (3*3) | 16 |
| | Deform-Out₁ | (128*128*16) | conv₁ | (3*3) | 16 |
| | conv₁ | (128*128*16) | maxpooling₁ | (2*2) | 16 |
| 2 | maxpooling₁ | (64*64*16) | DC₂ | (3*3) | 32 |
| | Deform-Out₂ | (64*64*32) | conv₂ | (3*3) | 32 |
| | conv₂ | (64*64*32) | maxpooling₂ | (2*2) | 32 |
| 3 | maxpooling₂ | (32*32*32) | DC₃ | (3*3) | 64 |
| | Deform-Out₃ | (32*32*64) | conv₃ | (3*3) | 64 |
| | conv₃ | (32*32*64) | maxpooling₃ | (2*2) | 64 |
| 4 | maxpooling₃ | (16*16*64) | DC₄ | (3*3) | 128 |
| | Deform-Out₄ | (16*16*128) | conv₄ | (3*3) | 128 |
| | conv₄ | (16*16*128) | maxpooling₄ | (2*2) | 128 |
| 5 | maxpooling₄ | (8*8*128) | conv₅ | (3*3) | 256 |
| | conv₅ | (8*8*256) | conv₆ | (3*3) | 256 |
| | conv₆ | (8*8*256) | Upsampling₁ | (2*2) | 256 |
| 6 | Upsampling₁ | (16*16*256) | DC₅ | (3*3) | 128 |
| | conv₄ | (16*16*128) | WG₁ | | 128 |
| | Deform-Out₅ | (16*16*128) | | | |
| | Upsampling₁ | (16*16*256) | concat₁ | | 384 |
| | Multiply₁ | (16*16*128) | | | |
| | concat₁ | (16*16*384) | conv₇ | (3*3) | 128 |
| | conv₇ | (16*16*128) | Upsampling₂ | (2*2) | 128 |
| 7 | Upsampling₂ | (32*32*128) | DC6 | (3*3) | 64 |
| | conv₃ | (32*32*64) | WG2 | | |
| | Deform-Out₆ | (32*32*64) | | | |
| | Upsampling₂ | (32*32*128) | concat₂ | | 192 |
| | Multiply₂ | (32*32*64) | | | |
| | concat₂ | (32*32*192) | conv₈ | (3*3) | 64 |
| | conv₈ | (32*32*64) | Upsampling₃ | (2*2) | 64 |
| 8 | Upsampling₃ | (64*64*64) | DC₇ | (3*3) | 32 |
| | conv₂ | (64*64*32) | WG₃ | | 32 |
| | Deform-Out₇ | (64*64*32) | | | |
| | Usampling₃ | (64*64*64) | concat₃ | | 96 |
| | Multiply₃ | (64*64*32) | | | |
| | concat₃ | (64*64*96) | conv₉ | (3*3) | 32 |
| | conv₉ | (64*64*32) | Usampling₄ | (2*2) | 32 |
| 9 | Upsampling₄ | (128*128*32) | DC₈ | (3*3) | 16 |
| | conv₁ | (128*128*16) | WG₄ | | 16 |
| | Deform-Out₈ | (128*128*16) | | | |
| | Usampling₄ | (128*128*32) | concat₄ | | 48 |
| | Multiply₄ | (128*128*16) | | | |
| | concat₄ | (128*128*48) | conv₁₀ | (3*3) | 16 |
| | conv₁₀ | (128*128*16) | conv₁₁ | (1*1) | 1 |
| | conv₁₁ | (128*128*1) | Sigmoid | | 1 |
| | | | activation | | |
| | Output | (128*128*1) | | | |

Weight Generation (WG) block

| Input | Layer | (Kernel Size) | #Kernels |
|---|---|---|---|
| conv_{X} | WG_{Z} | (3*3) | n |
| Deform-Block_{Y} | | | |
| Deform-Block_{Y} | conv^{a} | (1*1) | n |
| conv_{X} | conv^{b} | (1*1) | n |
| conv^{a} | Add | | |
| conv^{b} | | | |
| Add | ReLU activation | | |
| ReLU activation | S | (1*1) | 1 |
| S | Sigmoid Activation | | |
| | (SA) | | |
| conv_{X} | Multipy_{Z} | | |
| SA | | | |

Deformable Convolution (DC)

| Input | Layer | (Kernel Size) | #Kernels |
|---|---|---|---|
| Layer_{M} | DC_{Z} | (3*3) | n |
| Layer_{M} | conv^{d} | (3*3) | n. |
| | $( \begin{matrix}Δ = 2 D offsets ( Δx , Δy ) , \\ ω = Learned Kernel weights , \\ Deform - OutZ = ω * {conv}_{Δ}^{d}\end{matrix} )$ | | |

12. The Convolutional Neural network (CNNs) based system for image analysis as claimed in claim 3, wherein said WDU-Net (Deep Weighted Deformable Segmentation Network) based system architecture is adapted for accurate segmentation based detection of altered object image/diseased or infected volumes from medical images involving diverse image modalities including CT, MRI, PET, MRS, SPECT.

13. The Convolutional Neural network (CNNs) based system for image analysis as claimed in claim 8, wherein said WDU-Net (Deep Weighted Deformable Segmentation Network) based system architecture include means for (a) DC module capturing unknown geometric shape of tumor/diseased region, assisted by said WG module for suppressing unimportant features and highlighting the relevant ones, (b) FAS loss function involving a judicious combination of the Focal loss and Asymmetric Similarity loss that enabled effective determination of class imbalance, (c) training/iteration on various image patches for aiding improved and balanced learning by combining the outputs of ensembled classifiers by considering the similarity in major outputs, thereby adding to performance enhancement of image inference while arriving at a proper decision regarding the segmentation of ROI.

14. The Convolutional Neural network (CNNs) based system for image analysis as claimed in claim 1, and having WDU-Net (Deep Weighted Deformable Segmentation Network) based system architecture wherein
said imaging means include CT, MRI, PET, MRS, SPECT scanner based imaging means to generate predetermined image informative features;
said convolution network module includes:
(i) memory storage-cum-image processor means to support said predetermined representative image informative features, and process the same for sharing said features with detector-cum-image processor means incorporating deformable convolution (DC) module based processors and/or weight generation (WG) module based processors and/or focal loss module based processors, with said image detector processor modules processing for an area of consolidation by ablating representative image features post applying deformable convolution (DC) processing and/or weight generation (WG) processing to enable feature extraction and related image re-construction for efficiently demarcating and accurately segmenting subtle changes in medical images of objects/tissues;
(ii) display means to display demarcated and accurately segmented medical images including of altered object/diseased tissue volumes of arbitrary shapes and sizes by preferentially overcoming class imbalance in representative image features; and
(iii) processor means in operative connection for image supporting data acquisition, processing, detection and display.

15. The Convolutional Neural network (CNNs) based system for image analysis as claimed in claim 1, wherein the system includes trained image datasets of subjects from said scanner means including selected from CT, MRI, PET, MRS, SPECT images with preserved pixel values of medical images.

16. A method for efficient image segmentation focusing on Region of Interest (ROI) of varying shapes and sizes involving the system as claimed in claim 1, comprising:
carrying out convolution network module based semantic image segmentation through said processor means including U-net image segmentation means and variants thereof comprising U-net framework for down- and up-sampling of the image under analysis involving encoder and decoder arms for desired semantic image segmentation including:
following steps of deformable convolution in deformable convolution (DC) modules for a learnable and dynamic receptive field based deformation in free form of a sampling grid involving a 2D offset generator to said sampling grid points, down sampling based max pooling layers, up-sampling convolution layers and basic convolution modules for generating transformed images with precise detection and segmentation covering full regions of interest (ROI) including adaptive to the scale and shape of said ROI and based on input image feature generating an output image feature ‘F’, corresponding to pixel location (i, j) at output channel (m) of the encoder/decoder arms of the module as per Eq. 2 below,
$${ℱ}_{i , j}^{m} = {\sum }_{c = 0}^{C - 1} {\sum }_{p = - ⌊ K / 2 ⌋}^{⌊ K / 2 ⌋} {\sum }_{q = - ⌊ K / 2 ⌋}^{⌊ K / 2 ⌋} {ω}_{p , q}^{d} {X}_{\{ ( i + p ) + {Δ}_{x}^{( i + p )} \} , \{ ( j + q ) + {Δ}_{y}^{( j + q )} \}}^{c} . \qquad ( 2 )$$
wherein Δₓ and Δ_{y} in the generated output image feature cover capture of full Region of Interests (ROI) with said Δₓ being offset in x-direction and Δ_{y} being offset in y-direction enabling precise detection and segmentation covering full regions of interest (ROI) even with arbitrary shapes and sizes of diseased (infected) volumes/regions of images.

17. The method as claimed in claim 16, wherein said step of deformable convolution in said DC module to generate transformed image with precise detection and segmentation covering full regions of interest (ROI) involves said Δx and Δy as learned offset input parameter based pixel location shifting, to enable shift in pixel position along the abscissa and ordinate respectively generating said output feature ‘F’ based on image map generator corresponding to said pixel location (i, j) of input image feature generated by basic convolution module and including said Δₓ and Δ_{y} such as Δ={(Δⁿₓ, Δⁿ_{y})|1≤n≤K²} as said set of paired learnable offsets of size H×W on basic convolution operator to thus include in said output feature selectively shifted pixel location along abscissa and ordinate based on a dynamic offset value in turn enabling capture of receptive field adapted to the features of the input thus facilitating precise ROI segmentation,
with said basic convolution operator is as represented by Eq. 1 below:
$${ℱ}_{i , j}^{m} = {\sum }_{c = 0}^{C - 1} {\sum }_{p = - ⌊ K / 2 ⌋}^{⌊ K / 2 ⌋} {\sum }_{q = - ⌊ K / 2 ⌋}^{⌊ K / 2 ⌋} {ω}_{p , q}^{d} {X}_{\{ i + p \} , \{ j + q \}}^{c} . \qquad ( 1 )$$
where ‘c’={1, . . . , C} refers to the input channels, ‘m’={1, . . . , M} corresponding to the output channels, and K is assumed to be odd, when an input feature map X of size H×W×C is considered, where H represents the height, W corresponds to the width, and C refers to the number of input channels in basic convolution module operational based on said basic convolution operator operable preferably on a kernel size (K×K) producing an output feature map ‘F’ of size H×W×M with ‘M’ indicating the number of output channels considering, ω={ωⁱ|1≤i≤M; ωⁱ ∈(K×K)} is a set of learnable kernel weights of size K×K×M.

18. The method as claimed in claim 16, involving WDU-Net (Deep Weighted Deformable Segmentation Network) comprising group of Weight generation (WG) modules/blocks operative with said Deformable Convolution (DC) modules/blocks along said encoder and decoder arms of U-Net framework for generating weighted combination based feature maps on deformable convoluted (DC) transformed images with localization of segmented objects and/or generating highlighted boundaries thereof and related image segmentation for distinguishing objects in image which are visually similar or share common features involving dynamic assignment of importance to relevant spatial locations of the corresponding image feature including suppressing unimportant features and highlighting relevant features within said full regions of interest (ROI) generated by said deformable convolution (DC) module for advanced image segmentation.

19. The method as claimed in claim 18, wherein said step of weight generation involving said WG means/modules providing for computed weighted matrix based weighted feature map generation including:
(i) computing for basic convolution operator based on image inputs following Eq. 1:
$${ℱ}_{i , j}^{m} = {\sum }_{c = 0}^{C - 1} {\sum }_{p = - ⌊ K / 2 ⌋}^{⌊ K / 2 ⌋} {\sum }_{q = - ⌊ K / 2 ⌋}^{⌊ K / 2 ⌋} {ω}_{p , q}^{d} {X}_{\{ i + p \} , \{ j + q \}}^{c} . \qquad ( 1 )$$
where ‘c’={1, . . . , C} refers to the input channels, ‘m’={1, . . . , M} corresponding to the output channels, and K is assumed to be odd, when an input feature map X of size H×W×C is considered, where H represents the height, W corresponds to the width, and C refers to the number of input channels in basic convolution module operational based on said basic convolution operator operable preferably on a kernel size (K×K) producing an output feature map ‘F’ of size H×W×M with ‘M’ indicating the number of output channels considering, ω={ωⁱ|1≤i≤M; ωⁱ ∈(K×K)} is a set of learnable kernel weights of size K×K×M;
(ii) adding/introducing said convolution operator to combine said feature maps along the encoder arm pathway with the corresponding ones at the decoder arm pathway of said U-Net following the encoder pathway to be E={Eᵢ|1≤i≤L}, where L is number of levels in the network and Eᵢ corresponds to the feature map from the encoder pathway at level I, which analogously for the decoder pathway is D={Dᵢ|1≤i≤L}, where Dᵢ is the feature map from the decoder pathway at the same level I, where (Eᵢ, Dᵢ)∈H×W×C;
(iii) involving weightage matrix Sᵢ to be computed as per Eq. (3) below by employing basic convolution operator of said Eqn. (1) above on both said Eᵢ and Dᵢ to reduce their channel dimensions having convᵢ^{a}=C_{1×1}(Dᵢ) and convᵢ^{b}=C_{1×1}(Eᵢ), where C_{1×1} denotes the 1×1 convolution,
$${S}_{i} = {𝒞}_{1 \times 1 \times 1} \{ ReLU ( {conv}_{i}^{a} ⊕ {conv}_{i}^{b} ) \} . \qquad ( 3 )$$
and, normalized weightage matrix computing means wᵢ as given by Eq. 4 below involving sigmoid operation (σ) applied along spatial dimensions:
$${w}_{i} = σ ( {S}_{i} ) . \qquad ( 4 )$$
and finally (iv) generating weighted feature map Gᵢ involving computing means by element-wise multiplication ⊗ of the normalized weight matrix with the feature map Eᵢ from the encoder arm as per Eq. 5 hereunder:
$$𝒢 = {w}_{i} ⊗ {E}_{i} . \qquad ( 5 )$$
said weight generation computing means providing for assigning each pixel with necessary weight by suppressing unimportant features at encoding and decoding arm of the deformable convolution (DC) and generating weighted combination based feature maps on deformable convoluted (DC) transformed images with localization of segmented objects and/or generating highlighted boundaries thereof and related image segmentation for distinguishing objects in image which are visually similar or share common features involving dynamic assignment of importance to relevant spatial locations of the corresponding image feature including suppressing unimportant features and highlighting relevant features within said full regions of interest (ROI) generated by said deformable convolution (DC) module for advanced image segmentation.

20. The method as claimed in claim 18, wherein said method of efficient image segmentation by focusing on Region of Interest (ROI) of varying shapes and sizes and said steps of basic convolution operations, deformable convolution and Weight generation (WG) are based on trained image datasets including subjects from said diverse image scanners selected from CT, MRI, PET, MRS, SPECT images.
